(19) United States
(12) Patent Application Publication
(10) Pub. No.: US 2024/0247144 A1
(43) Pub. Date: Jul. 25, 2024

(54) Flame-Retardant Composition Containing 0.040 to 0.095 wt.% of a Flame Retardant

(71) Applicant: Covestro Deutschland AG, Leverkusen (DE)

(72) Inventors: Helmut Werner Heuer, Siegen (DE); Michael Erkelenz, Duisburg (DE); Christian Kaiser, Tönisvorst (DE)

(21) Appl. No.: 18/561,580

(22) PCT Filed: May 16, 2022
(86) PCT No.: PCT/EP2022/063136

§ 371 Date: Nov. 16, 2023

(30) Foreign Application Priority Data
May 17, 2021 (EP) 21174020.4

(51) Int. Cl. C08L 69/00; C08G 63/195; C08J 5/04; C08K 5/00; C08K 5/42

(52) U.S. Cl. CPC C08L 69/00; C08G 63/195; C08J 5/043; C08K 5/0066; C08K 5/42; C08J 2369/00; C08K 2201/019; C08L 2201/02; C08L 2205/025

(57) ABSTRACT

The present invention relates to compositions containing linear polycarbonate, branched polycarbonate and a small amount of salts of sulfonic acid, sulfonamide or sulfonimide derivatives. The invention likewise relates to the use of branched polycarbonate in a polycarbonate composition for achieving a classification according to UL94 of V-0 at a layer thickness of 2.00 mm.

### CROSS-REFERENCE TO RELATED APPLICATIONS

This application is the United States national phase of International Application No. PCT/EP2022/063136 filed May 16, 2022, and claims priority to European Patent Application No. 21174020.4 filed May 17, 2021, the disclosures of which are hereby incorporated by reference in their entireties.

### BACKGROUND

### Technical Field

The present invention relates to compositions containing linear polycarbonate, branched polycarbonate and a small amount of salts of sulfonic acid, sulfonamide or sulfonimide derivatives. The invention likewise relates to the use of branched polycarbonate in a polycarbonate composition for achieving a classification according to UL94 of V-0 at a layer thickness of 2.00 mm, preferably 1.5 mm.

### Description of Related Art

Polycarbonate compositions enjoy a broad range of possible applications. However, especially for thin-walled applications, they often additionally need to be additized with flame retardants in order to be able to satisfy the high requirements on flame retardancy properties. However, reducing the amount, or even banning, various flame retardants is a consistent focal point since, depending on the chemical nature of the flame retardants, they are already classed as “substances of very high concern” (SVHCs).

For example, under the action of heat, halogenated flame retardants can release undesired halogen radicals and resulting conversion products that are harmful to the environment. In many countries in the world, therefore, the use of such flame retardants is avoided.

A common flame retardant in polycarbonate compositions is potassium perfluorobutanesulfonate (also known as Rimar salt or C4 salt). Some PFASs (polyfluoroalkyl substances) are already considered substances of very high concern under REACH since they are very long-lived, accumulate in organisms (bioaccumulation) and can be harmful to humans. For substances of very high concern, the REACH Regulation provides for particular duties of disclosure, and there may be a registration requirement, i.e. only explicitly authorized uses may continue to be used.

The German Federal Environmental Agency, the UBA, considers it necessary, in particular considering the precautionary principle, to regulate the whole substance group since all PFASs could remain in the environment for long periods of time. Therefore, the UBA, together with other authorities in Germany, the Netherlands, Denmark, Sweden and Norway, is developing an EU-wide restriction proposal under REACH for this substance group.

The European Chemicals Agency (ECHA) has now placed the compound “perfluorobutanesulfonic acid (PFBS) and its salts” on the REACH candidate list of SVHC substances. This therefore also affects the C4 salt. This compound has for a long time been used for the reproducibly good flame retardancy improvement of polycarbonate compositions. The provision of corresponding polycarbonate compositions with comparable flame retardancy but with the use of less potassium perfluorobutanesulfonate therefore constitutes a major challenge.

WO2008/060714 A2 describes that flame-retardant polycarbonate compositions with simultaneously good flow properties and good transparency can be obtained by terminating the polycarbonate used with cyanophenol end groups. Example 16 in this document shows a composition comprising 70 parts linear polycarbonate, 30 parts branched polycarbonate and 0.08 parts potassium perfluorobutanesulfonate. This composition has a UL94 classification of V-0 at 2.5 mm. However, at a lower layer thickness of 1.57 mm, it is identified as “dripping”. The use of cyanophenol end groups for the polycarbonate can, however, also be disadvantageous. The cyano group is a reactive group that can lead to conversion products instabilities in the polycarbonate. In general, such reactions lead to undesired modifications to the colour of the polycarbonate. The use of cyanophenol is additionally relatively expensive.

WO03/050176 A1 relates to translucent flame-retardant polycarbonate compositions which, without the use of chlorinated or brominated flame retardants, nevertheless exhibit good flame retardancy and at the same time have a high transparency and a low haze. The solution proposed in that document is a composition comprising a branched polycarbonate, PTFE and, inter alia, also potassium perfluorobutanesulfonate. Comparative example 13 in this document describes a composition comprising 82 parts linear polycarbonate, 18 parts branched polycarbonate and 0.08 parts potassium perfluorobutanesulfonate. The branched polycarbonate has a degree of branching of 0.3 mol and this example additionally does not exhibit any good flame retardancy.

Document WO2012/06292 A1 describes polycarbonate compositions having good flame retardancy at low layer thicknesses without the use of chlorinated or brominated flame retardants. To this end, the use of a linear phenyl-containing siloxane and a cyclic phenyl-containing siloxane is proposed. The examples Batch 1-3 to 1-7 in Table 3 of WO2012/06292 A1 describe compositions comprising 70 parts linear polycarbonate, 30 parts branched polycarbonate and 0.08 parts potassium perfluorobutanesulfonate. However, the degree of branching of the polycarbonate used is not explicitly stated here, though it appears to be relatively low.

DE60223842 T2 in the examples describes mixtures of a branched polycarbonate, linear polycarbonate, potassium perfluorobutanesulfonate and a cyclic siloxane. This document provides no statements concerning the end groups of the branched and/or linear polycarbonate. In addition, the disclosed degree of branching appears to be relatively low.

WO2015/140671 A1 describes flame-retardant compositions composed of linear and branched polycarbonates, sodium dodecylbenzenesulfonate and a cyclic siloxane. The degree of branching is not disclosed in the examples.

KR20130124930A discloses polycarbonate compositions comprising linear and branched polycarbonate and a lactone-modified potassium perfluorobutanesulfonate. This document also provides no statement concerning the end groups of the linear and/or branched polycarbonate. Nor does this document disclose a degree of branching in the examples either.

WO01/83606A1 describes a composition composed of linear and branched polycarbonate, perfluoroalkanesulfonates and cyclic siloxanes. No mention is made of the end groups of the polycarbonates used. The branched polycarbonate of the composition of example 2 also has a low degree of branching of 0.42 mol %.

### SUMMARY

Proceeding from this prior art, the problem addressed by the present invention consisted in overcoming at least one disadvantage of the prior art. The problem addressed by the present invention consisted in particular in providing a polycarbonate-containing composition that contains at most 0.095% by weight of a compound selected from the group of alkali metal, alkaline earth metal or ammonium salts of aliphatic or aromatic sulfonic acid, sulfonamide or sulfonimide derivatives and combinations thereof and simultaneously has at least a flame retardancy corresponding to the UL94 classification of V-0 at 2.0 mm, preferably at 1.5 mm. The thermal properties and/or the processibility of the composition should in addition not be negatively affected compared to a composition having higher contents of compounds selected from the group of alkali metal, alkaline earth metal or ammonium salts of aliphatic or aromatic sulfonic acid, sulfonamide or sulfonimide derivatives and combinations thereof.

At least one, preferably all, of the abovementioned problems have been solved by the present invention. It has been found, surprisingly, that a combination of the use of a specific amount of a compound selected from the group of alkali metal, alkaline earth metal or ammonium salts of aliphatic or aromatic sulfonic acid, sulfonamide or sulfonimide derivatives and combinations thereof, and a polycarbonate having a specific degree of branching, results in a flame retardancy corresponding at least to a UL94 classification of V-0 at 2.00 mm, preferably 1.5 mm. The composition according to the invention therefore reduces the amount of a compound on the SVHC REACH list of the ECHA. It has been found here, surprisingly, that it is possible to dispense with the use of cyanophenol end groups in the branched polycarbonate and nevertheless achieve good flame retardancy. At the same time, the polycarbonate end groups used are no longer reactive, resulting in a more stable polycarbonate composition than when using cyanophenol as end group. More favourable terminating groups can also be used. It is surprising in particular here that it is possible with preference to dispense with further additives for the polycarbonate composition, which are frequently used to achieve high flame retardancy at thin layer thicknesses. Inter alia, the composition, even without PTFE, without a halogenated flame retardant and/or also without a polysiloxane-polycarbonate block co-condensate, preferably has at least a UL94 classification of V-0 at a layer thickness of 2.0 mm, preferably 1.5 mm.

### DESCRIPTION

It has additionally been found that the compositions according to the invention have improved flowability and hence better processibility than comparable composition having a relatively high content of compounds selected from the group of alkali metal, alkaline earth metal or ammonium salts of aliphatic or aromatic sulfonic acid, sulfonamide or sulfonimide derivatives and combinations thereof. The thermal properties of the composition according to the invention also remain virtually comparable to those with relatively high contents of said compound.

The invention provides a composition comprising
(A) 3% to 85% by weight, in particular to 84.96% by weight, preferably 4% to 82% by weight, in particular to 81.96% by weight, particularly preferably 14% to 81% by weight, in particular to 80.96% by weight, and especially preferably 19% to 80% by weight, in particular to 79.96% by weight, of a linear polycarbonate,
(B) 15% to 96% by weight, preferably 18% to 95% by weight, particularly preferably 19% to 85% by weight and especially preferably 20% to 80% by weight, of a polycarbonate having a degree of branching of 1.01 to 1.5 mol % and not comprising any end groups of formula (I):

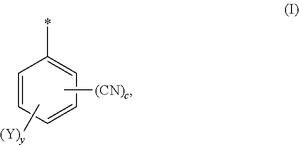

in which each Y independently is a halogen, an alkyl group having 1 to 3 carbon atoms, an alkoxy group having 1 to 3 carbon atoms, an arylalkyl group having 7 to 12 carbon atoms, an alkylaryl group or a nitro group,
y is 0 to 4 and c is 1 to 5, with the proviso that y+c is 1 to 5, and in which * represents the position at which formula (I) terminates the polycarbonate (B),
(C) 0.040% to 0.095% by weight of a compound selected from the group of alkali metal, alkaline earth metal or ammonium salts of aliphatic or aromatic sulfonic acid, sulfonamide or sulfonimide derivatives and combinations thereof,
(D) 0% to 40% by weight of a reinforcing fibre and
(E) a cyclic siloxane of formula (R¹₂SiO)_{y} and/or a siloxane comprising a trifunctional siloxane unit of formula R²SiO_{3/2},
in which each R¹ independently is a monovalent aliphatic or aromatic hydrocarbon group or a fluorinated hydrocarbon group having in each case 1 to 18 carbon atoms and y is a number from 3 to 12 and
in which each R² independently is hydrogen, a monovalent aliphatic or aromatic hydrocarbon group having in each case 1 to 18 carbon atoms or a monovalent alkoxy group having 1 to 18 carbon atoms,
   where the % by weight are based on the sum total of components (A) to (E).

According to the invention, the component (A) used is a linear polycarbonate. According to the invention, the term “linear” is used in particular for delimitation with respect to “branched” component (B). The person skilled in the art is familiar with linear polycarbonates. They are also aware that many polycarbonates that are referred to as “linear” may contain a small proportion of branches. This results in part from the preparation process of the polycarbonate. One example of these intrinsic branches is that of so-called Fries structures, as described for melt polycarbonates in EP 1 506 249 A1. According to the invention, the term “linear” preferably means that the polycarbonate has a degree of branching of <0.4 mol %. The degree of branching is defined here as specified below with respect to component (B).

Component (A) is preferably an aromatic polycarbonate. In the context according to the invention. the term “polycarbonate” is understood to mean both homopolycarbonates and copolycarbonates. According to the invention, it is also possible to use mixtures of polycarbonates, but with each of the individual components then being linear.

Compositions according to the invention contain 3% to 85% by weight, in particular to 84.96% by weight, of component (A), preferably 4% to 82% by weight, in particular to 81.96% by weight, particularly preferably 14% to 81% by weight, in particular to 80.96% by weight, and especially preferably 19% to 80% by weight, in particular to 79.96% by weight. A proportion of component (A) of 3% to 85% by weight, or of the above-described preferred % by weight, of the overall composition, means according to the invention that the composition is based on polycarbonate.

The linear polycarbonates present in the compositions are prepared in a known manner from dihydroxyaryl compounds, carbonic acid derivatives, and optionally chain terminators and branching agents.

Details of the preparation of polycarbonates have been set out in many patent specifications over the past 40 years or so. Reference may be made here by way of example to Schnell, “Chemistry and Physics of Polycarbonates”, Polymer Reviews, Volume 9, Interscience Publishers, New York, London, Sydney 1964, to D. Freitag, U. Grigo, P. R. Müller, H. Nouvertnd, BAYER AG, “Polycarbonates” in Encyclopedia of Polymer Science and Engineering, Volume 11, Second Edition, 1988, pages 648-718 and finally to U. Grigo, K. Kirchner and P. R. Müller “Polycarbonate” [Polycarbonates] in Becker/Braun, Kunststoff-Handbuch [Plastics Handbook], volume 3/1, Polycarbonate, Polyacetale, Polyester, Celluloseester [Polycarbonates, Polyacetals, Polyesters, Cellulose Esters], Carl Hanser Verlag Munich, Vienna 1992, pages 117 to 299.

The polycarbonates are prepared, for example, by reaction of dihydroxyaryl compounds with carbonyl halides, preferably phosgene, and/or with aromatic dicarbonyl dihalides, preferably benzenedicarbonyl dihalides, by the interfacial process, optionally with use of chain terminators and optionally with use of trifunctional or more than trifunctional branching agents. Likewise possible is preparation via a melt polymerization method, by reacting dihydroxyaryl compounds with, for example, diphenyl carbonate.

Dihydroxyaryl compounds suitable for the preparation of the polycarbonates are for example resorcinol, dihydroxydiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from derivatives of isatin or phenolphthalein, and the ring-alkylated and ring-arylated compounds thereof.

Preferred dihydroxyaryl compounds are 4,4′-dihydroxydiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane and also the bisphenols (Aa) to (Ca)

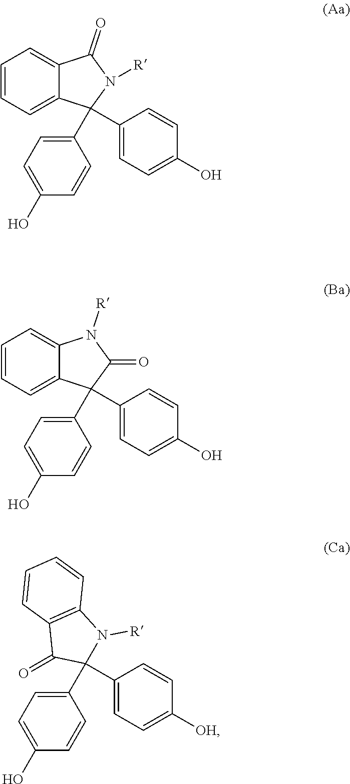

in which each R¹ is C1-to C4-alkyl, aralkyl or aryl, preferably methyl or phenyl, very particularly preferably methyl.

Particularly preferred bisphenols are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane, 4,4′-dihydroxydiphenyl and dimethylbisphenol A, and also the bisphenols of formulae (Aa), (Ba) and (Ca). Very particular preference is given to bisphenol A.

These and other suitable dihydroxyaryl compounds are described by way of example in U.S. Pat. No. 3,028,635 A, 2,999,825 A, 3,148,172A, 2,991,273 A, 3,271,367A, 4,982,014A and 2,999,846 A, in DE 1 570 703 A, DE 2063 050 A, DE 2 036 052 A, DE 2 211 956 A and DE 3 832 396 A, in FR 1 561 518 A, in the monograph “H. Schnell, Chemistry and Physics of Polycarbonates, Interscience Publishers, New York 1964” and also in JP 62039/1986 A, JP 62040/1986 A and JP 105550/1986 A.

In the case of homopolycarbonates only one dihydroxyaryl compound is used; in the case of copolycarbonates two or more dihydroxyaryl compounds are used.

Examples of suitable carbonic acid derivatives are phosgene or diphenyl carbonate.

Suitable chain terminators that may be used in the preparation of the polycarbonates are monophenols. Examples of suitable monophenols include phenol itself, alkylphenols such as cresols, p-tert-butylphenol, cumylphenol, and also mixtures thereof. However, preferably no cyanophenol is used as chain terminator.

It is preferable in particular for the linear polycarbonate (A) not to comprise any end groups of formula (I):

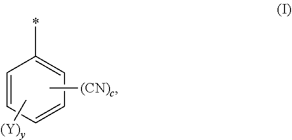

in which Y, y and c are as defined above. It is preferable in formula (I) with respect to component (A) for y to be 1 to 2 and c to be 1 to 2. It is particularly preferable in formula (I) for y to be 0 and c to be 1 to 2. Very particularly preferably, formula (I) is para-cyanophenyl or 3,4-dicyanophenyl.

It is furthermore preferable according to the invention for the linear polycarbonate (A) and/or optionally also the polycarbonate (B) described further below to comprise end groups of formulae (2a), (2b) and/or (2c):

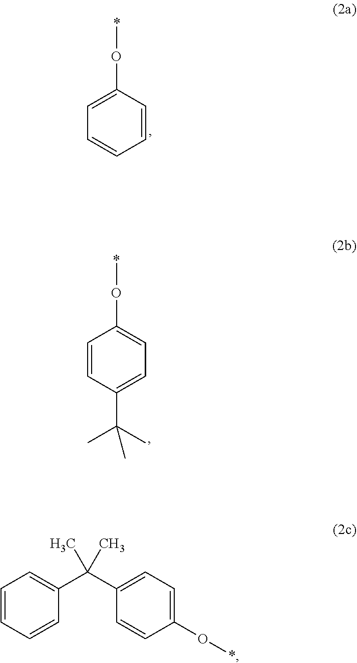

where * represents the position at which formulae (2a), (2b) and (2c) terminate the respective polycarbonate (A) and/or (B). It is furthermore preferable for the linear polycarbonate (A) to have end groups of formulae (2a) and/or (2b), especially preferably of formula (2a).

The amount of chain terminator to be used is preferably 0.1 to 5 mol %, based on moles of dihydroxyaryl compounds used in each case. The chain terminators may be added before, during or after the reaction with a carbonic acid derivative.

Particularly preferred polycarbonates (A) are the homopolycarbonate based on bisphenol A, the copolycarbonates based on 1,1-bis(4-hydroxyphenyl)-3,3,5-trimethylcyclohexane and 4,4′-dihydroxydiphenyl and also the copolycarbonates based on the two monomers bisphenol A and 1,1-bis(4-hydroxyphenyl)-3,3,5-trimethylcyclohexane, and also homo- or copolycarbonates derived from the dihydroxyaryl compounds of formulae (Ia), (IIa) and (IIIa), especially with bisphenol A.

The polycarbonates (A) preferably have weight-average molecular weights Mw of 15 000 g/mol to 40 000 g/mol, more preferably to 34 000 g/mol, particularly preferably of 17 000 g/mol to 33 000 g/mol, in particular of 19 000 g/mol to 32 000 g/mol, determined by gel permeation chromatography, calibrated against bisphenol A polycarbonate standards using dichloromethane as eluent, calibration with linear polycarbonates (formed from bisphenol A and phosgene) of known molar mass distribution from PSS Polymer Standards Service GmbH, Germany, and calibration by method 2301-0257502-09D (2009 German-language edition) from Currenta GmbH & Co. OHG, Leverkusen. The eluent is dichloromethane. Column combination of crosslinked styrene-divinylbenzene resins. Diameter of analytical columns: 7.5 mm; length: 300 mm. Particle sizes of column material: 3 μm to 20 μm. Concentration of solutions: 0.2% by weight. Flow rate: 1.0 ml/min, temperature of solutions: 30° C. Use of UV and/or RI detection.

The melt volume flow rate (MVR), determined to ISO 1133-1:2012-03 at 300° C. with 1.2 kg load, is 3 to 40 cm³/(10 min), preferably 4 to 35 cm³/(10 min).

For incorporation of possible additives, component (A) is preferably used in the form of powders, pellets or mixtures of powders and pellets.

Furthermore used according to the invention, as component (B), is a polycarbonate having a degree of branching of 1.01 to 1.5 mol % and not comprising any end groups of formula (I):

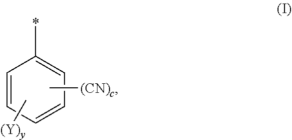

in which each Y independently is a halogen, an alkyl group having 1 to 3 carbon atoms, an alkoxy group having 1 to 3 carbon atoms, an arylalkyl group having 7 to 12 carbon atoms, an alkylaryl group or a nitro group, y is 0 to 4 and c is 1 to 5, with the proviso that y+c is 1 to 5, and in which * represents the position at which formula (I) terminates the polycarbonate (B).

It has been found according to the invention that the use of component (B) enables a reduction in the amount of component (C) and yet nevertheless the resulting shaped bodies of the composition exhibit good flame retardancy, i.e. at least a flame retardancy according to the UL94 classification of V-0 at 2.0 mm, preferably at 1.5 mm. At the same time the thermal properties of the composition are virtually retained compared to a composition containing more (C) but no (B). In addition, the flowability of the compositions according to the invention is better than the comparable compositions having a higher amount of (C) and no (B).

It is preferable in formula (I) with respect to component (B) for y to be 1 to 2 and c to be 1 to 2. It is particularly preferable in formula (I) for y to be 0 and c to be 1 to 2. Very particularly preferably, formula (I) is para-cyanophenyl or 3,4-dicyanophenyl.

It is furthermore preferable according to the invention for the polycarbonate (B) and optionally also the linear polycarbonate (A) to comprise end groups of formulae (2a), (2b) and/or (2c):

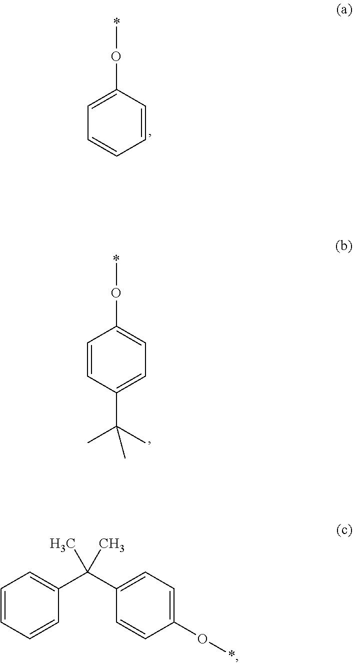

where * represents the position at which formulae (2a), (2b) and (2c) terminate the respective polycarbonate (A) and/or (B). It is furthermore preferable for the branched polycarbonate (B) to have end groups of formulae (2a) and/or (2b), especially preferably of formula (2b).

It is especially preferable for the linear polycarbonate (A) and the branched polycarbonate (B) to have end groups of formulae (2a) and/or (2b). Very particularly preferably, the linear polycarbonate (A) has end groups of formula (2a) and the branched polycarbonate (B) has end groups of formula (2b).

According to the invention, reference is also made in the case of component (B) or polycarbonate (B) to branched polycarbonate. This preferably has a degree of branching of 0.8 to 1.5 mol %, preferably 0.9 to 1.3 mol %, very particularly preferably of 1.00 to 1.25 mol %, particularly preferably of 1.1 to 1.2 mol %.

According to the invention, component (B), i.e. polycarbonate (B), has a degree of branching of 1.01 to 1.5 mol %, preferably of 1.02 to 1.3 mol %, particularly preferably of 1.03 to 1.25 mol %, more particularly preferably of 1.04 to 1.20 mol %, more preferably of 1.05 to 1.15 mol %, more preferably of 1.06 to 1.13 mol %, and very particularly preferably of 1.07 to 1.1 mol %.

According to the present invention, the term “branched” is to be understood as meaning that the polycarbonate has a plurality of branching points, or a degree of branching. This degree of branching is reported in mol % and is calculated according to the following formula:

$$mol \% ( degree of branching ) = mol ( branching agent ) \text{} / ( mol ( branching agent ) + ( mol ( dihydroxy compound ) ) \cdot 100$$

where the “branching agent” is the branching agent which comprises at least 3 functional groups and the “dihydroxy compound” is the compound having only 2 functional groups and used for preparation of the polycarbonate. In the examples, for example, the branching agent used is THPE and the dihydroxy compound is BPA. The following then results:

$$mol \% ( degree of branching ) = ( m ( THPE ) [ g ] / M ( THPE ) [ g / mol ] ) \text{} / \text{} ( ( m ( THPE ) [ g / mol ] ) + ( m ( BPA ) [ g ] / M ( BPA ) [ g / mol ] ) ) \cdot 100$$

where M(THPE)=306 g/mol and M(BPA)=228 g/mol and m(THPE) and m(BPA) are the mass of the corresponding reactants in the preparation of the branched polycarbonate.

Although the mol % of the degree of branching is calculated on the basis of the reactants used, the term “degree of branching” relates, according to the invention, to the chemical structure of the branching agent as present in the polycarbonate after the reaction. It is preferable here for the polycarbonate (B) to have branches selected from the group consisting of formulae (IIa) to (IIf) and any desired mixtures thereof:

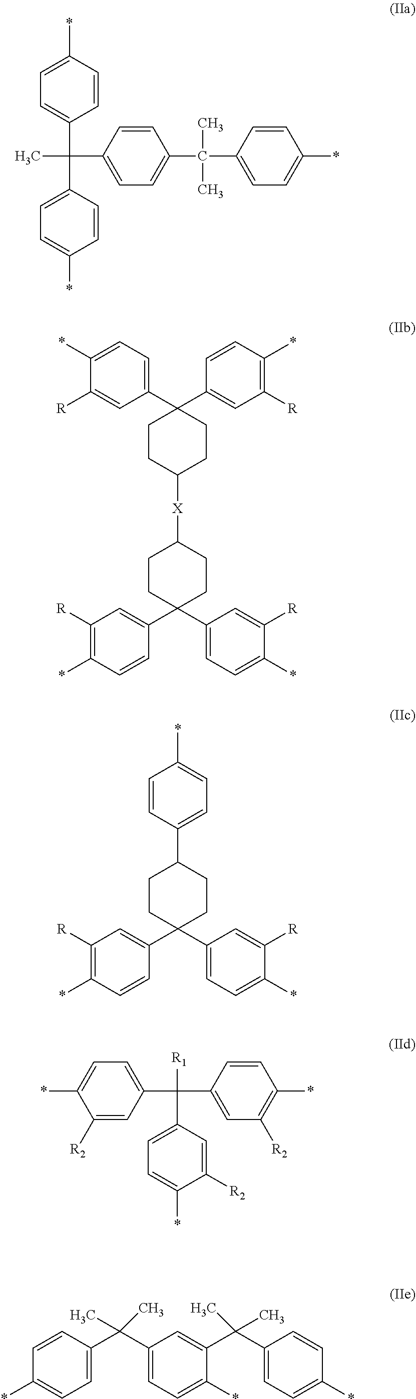

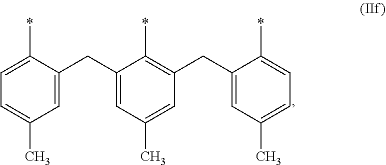 [SMILES: *c1ccc(C)cc1Cc1cc(C)cc(Cc2cc(C)ccc2*)c1*]

where * represents the positions which connect the branches to the polycarbonate chain
and
each R independently is H and an alkyl, preferably H and methyl,
X is a linear or branched alkyl or a single bond, preferably C(CH₃)₂ or a single bond,
each R₁ independently is H and an alkyl, preferably H and methyl and
each R₂ independently is H and an alkyl, preferably H and methyl.

The branched polycarbonate (B) may have one type of the branches shown above or a mixture of two or more branches. In a preferred embodiment, the polycarbonate (B) has branches of formula (IId). It is especially preferable here for R₁ and R₂ to independently be H or alkyl. Particularly preferably, R₁ is methyl and R₂ is H. Such a branching structure results when THPE is used as branching agent.

The polycarbonate (B) may preferably be prepared by the routes described above with respect to polycarbonate (A). However, in this case the polycarbonate (B) is preferably prepared by the interfacial process. This makes it possible to exactly set the degree of branching.

Dihydroxyaryl compounds suitable for the preparation of the polycarbonates (B) are for example resorcinol, dihydroxydiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from derivatives of isatin or phenolphthalein, and the ring-alkylated and ring-arylated compounds thereof.

Preferred dihydroxyaryl compounds are 4,4′-dihydroxydiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane and also the bisphenols (Aa) to (Ca)

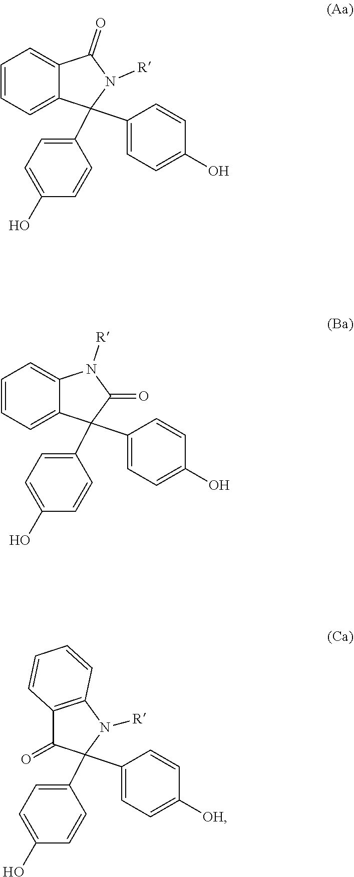

in which each R¹ is C1-to C4-alkyl, aralkyl or aryl, preferably methyl or phenyl, very particularly preferably methyl.

Particularly preferred bisphenols are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane, 4,4′-dihydroxydiphenyl and dimethylbisphenol A, and also the bisphenols of formulae (Aa), (Ba) and (Ca). Very particular preference is given to bisphenol A.

As already described above, branching agents are used in the synthesis of the polycarbonate (B) in order to obtain the corresponding degree of branching. Suitable branching agents are the trifunctional or more than trifunctional compounds known in polycarbonate chemistry, in particular those having three or more than three phenolic OH groups.

Examples of suitable branching agents are 1,3,5-tri(4-hydroxyphenyl)benzene, 1,1,1-tri(4-hydroxyphenyl)ethane, tri(4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane, and 1,4-bis((4′,4″-dihydroxytriphenyl)methyl)benzene, and 3,3-bis(3-methyl-4-hydroxyphenyl)-2-oxo-2,3-dihydroindole.

Especial preference is given to branching agents of formulae (IIIa) to (IIIf):

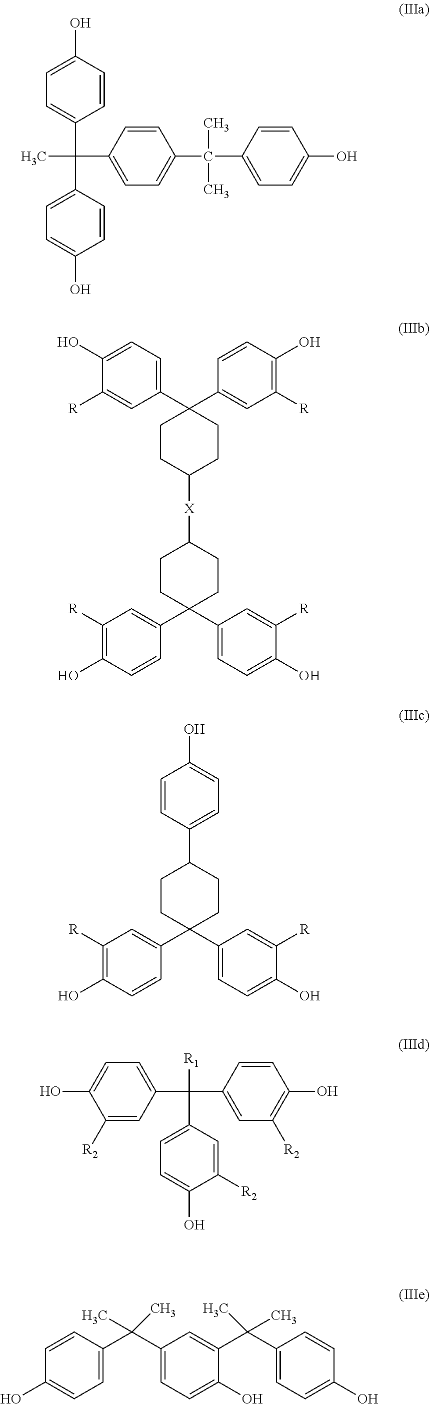

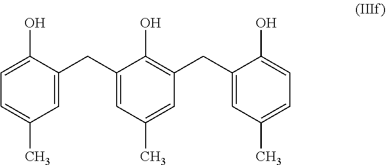 [SMILES: Cc1ccc(O)c(Cc2cc(C)cc(Cc3cc(C)ccc3O)c2O)c1]

in which
each R independently is H and an alkyl, preferably H and methyl,
X is a linear or branched alkyl or a single bond, preferably C(CH₃)₂ or a single bond,
each R₁ independently is H and an alkyl, preferably H and methyl and
each R₂ independently is H and an alkyl, preferably H and methyl.

Especial preference is given to using a branching agent of formula (IId). It is especially preferable here for R₁ and R₂ to independently be H or alkyl. Particularly preferably, R₁ is methyl and R₂ is H.

The branching agents can either form an initial charge with the dihydroxyaryl compounds and the chain terminators in the aqueous alkaline phase or can be added, dissolved in an organic solvent, before the phosgenation. In the case of the transesterification method, the branching agents are used together with the dihydroxyaryl compounds.

The polycarbonates (B) preferably have weight-average molecular weights Mw of 15 000 g/mol to 40 000 g/mol, more preferably 18 000 to 34 000 g/mol, particularly preferably of 22 000 g/mol to 33 000 g/mol, in particular of 23 000 g/mol to 32 000 g/mol, determined by gel permeation chromatography, calibrated against bisphenol A polycarbonate standards using dichloromethane as eluent, calibration with linear polycarbonates (formed from bisphenol A and phosgene) of known molar mass distribution from PSS Polymer Standards Service GmbH, Germany, and calibration by method 2301-0257502-09D (2009 German-language edition) from Currenta GmbH & Co. OHG, Leverkusen. The eluent is dichloromethane. Column combination of crosslinked styrene-divinylbenzene resins. Diameter of analytical columns: 7.5 mm; length: 300 mm. Particle sizes of the column material: 3 μm to 20 μm. Concentration of the solutions: 0.2% by weight. Flow rate: 1.0 ml/min, temperature of solutions: 30° C. Use of UV and/or RI detection.

The melt volume flow rate (MVR), determined to ISO 1133-1:2012-03 at 300° C. with 1.2 kg load, is 3 to 40 cm³/(10 min), preferably 4 to 35 cm³/(10 min).

According to the invention, the composition comprises 15% to 96% by weight of component (B), preferably 18% to 95% by weight, particularly preferably 19% to 85% by weight, very particularly preferably 20% to 80% by weight. The person skilled in the art is aware that component (B) is more expensive than component (A). Therefore, said person will seek to optimize the ratio of (A) to (B) so that good properties (e.g. sufficient flame retardancy, good processibility, etc.) result, yet for the desired applications economical compositions are nevertheless formed.

According to the invention, it is possible for the composition to further comprise blend partners that differ from components (A) and (B). These are preferably thermoplastic polymers.

The composition according to the invention further comprises, as component (C), a compound selected from the group of alkali metal, alkaline earth metal or ammonium salts of aliphatic or aromatic sulfonic acid, sulfonamide or sulfonimide derivatives and combinations thereof.

It will be appreciated that a combination of two or more such flame retardants may also be involved. It will also be appreciated that two or more representatives from one of the compound groups mentioned may also be involved.

According to the invention, “derivatives” here and elsewhere herein are understood to mean those compounds having a molecular structure that has, in place of a hydrogen atom or a functional group, a different atom or a different group of atoms or in which one or more atoms/groups of atoms has/have been removed. The parent compound is thus still recognizable.

It is preferable in particular for the composition according to the invention to comprise, as component (C), a compound selected from the group of aliphatic or aromatic sulfonic acid derivatives. This compound particularly preferably does not comprise any lactone-modified derivatives. In particular, this compound does not comprise those derivatives as are described in KR20130124930 A.

As flame retardant, compositions according to the invention particularly preferably comprise one or more compounds selected from the group consisting of sodium or potassium perfluorobutanesulfate, sodium or potassium perfluoromethanesulfonate, sodium or potassium perfluorooctanesulfate, sodium or potassium 2,5-dichlorobenzenesulfate, sodium or potassium 2,4,5-trichlorobenzenesulfate, sodium or potassium diphenylsulfone sulfonate, sodium or potassium 2-formylbenzenesulfonate, sodium or potassium (N-benzenesulfonyl)benzenesulfonamide, partially fluorinated sodium or potassium fluoroalkylsulfonates, or mixtures thereof.

Preference is given to using sodium or potassium perfluorobutanesulfate, sodium or potassium perfluorooctanesulfate, sodium or potassium diphenylsulfone sulfonate, or mixtures thereof. Very particular preference is given to potassium perfluoro-1-butanesulfonate, which is commercially available, inter alia, as Bayowet® C4 from Lanxess, Leverkusen, Germany. Likewise used with preference is potassium diphenylsulfone sulfonate, also known as KSS (CAS 63316-43-8). Very particular preference is given to potassium perfluoro-1-butanesulfonate and/or potassium diphenylsulfone sulfonate.

The compositions according to the invention contain 0.040% to 0.095% by weight, preferably 0.045% to 0.094% by weight, further preferably 0.050% to 0.093% by weight, further preferably 0.055% to 0.092% by weight, further preferably 0.060% to 0.091% by weight, further preferably 0.065% to 0.090% by weight, further preferably 0.070% to 0.085% by weight of component (C).

The composition according to the invention may also contain a reinforcing fibre as component (D). These reinforcing fibres may preferably be selected from glass fibres or carbon fibres.

The glass fibres are typically based on a glass composition selected from the group of the M, E, A, S, R, AR, ECR, D, Q or C glasses, preference being given to E, S or C glass.

The glass fibres may be used in the form of chopped glass fibres, long and also short fibres, ground fibres, glass fibre weaves or mixtures of the abovementioned forms, preference being given to the use of chopped glass fibres and ground fibres. Particular preference is given to using chopped glass fibres.

The preferred fibre length of the chopped glass fibres before compounding is 0.5 to 10 mm, more preferably 1.0 to 8 mm, very particularly preferably 1.5 to 6 mm.

Chopped glass fibres may be used with different cross sections. Preference is given to using round, elliptical, oval, figure-of-8 and flat cross sections, particular preference being given to round, oval and flat cross sections.

The diameter of the employed round fibres prior to compounding is preferably 5 to 25 μm, more preferably 6 to 20 μm, particularly preferably 7 to 17 μm, determined by means of analysis by light microscopy.

Preferred flat and oval glass fibres have a cross-sectional ratio of height to width of about 1.0:1.2 to 1.0:8.0, preferably 1.0:1.5 to 1.0:6.0, particularly preferably 1.0:2.0 to 1.0:4.0.

Preferred flat and oval glass fibres have an average fibre height of 4 μm to 17 μm, more preferably of 6 μm to 12 μm and particularly preferably 6 μm to 8 μm, and an average fibre width of 12 μm to 30 μm, more preferably 14 μm to 28 μm and particularly preferably 16 μm to 26 μm. The fibre dimensions are preferably determined by means of analysis by light microscopy.

The glass fibres are preferably modified with a glass sizing agent on the surface of the glass fibre. Preferred glass sizing agents include epoxy-modified, polyurethane-modified and unmodified silane compounds and mixtures of the aforementioned silane compounds. The glass fibres may also not have been modified with a glass sizing agent.

It is a feature of the glass fibres used that the selection of the fibre is not limited by the interaction characteristics of the fibre with the polycarbonate matrix. An improvement in the properties according to the invention of the compositions is obtained both for strong binding to the polymer matrix and in the case of a non-binding fibre.

Binding of the glass fibres to the polymer matrix is apparent in the low-temperature fracture surfaces in scanning electron micrographs, with the majority of the broken glass fibres being broken at the same height as the matrix and only individually glass fibres protruding from the matrix. In the converse case of non-binding characteristics, scanning electron micrographs show that the glass fibres protrude significantly from the matrix or have slid out completely in low-temperature fracture.

It is also possible according to the invention to use carbon fibres as reinforcing fibres. Carbon fibres are typically industrially manufactured from precursors such as polyacrylic fibres, for example, by pyrolysis (carbonization). Long fibres and short fibres can be used in the compositions according to the invention. Preference is given to using short fibres.

The length of the chopped fibres is preferably between 3 mm and 125 mm. Particular preference is given to using fibres of 3 mm to 25 mm in length.

In addition to fibres of round cross section, fibres of cubic dimension (platelet-shaped) are also usable.

In addition to chopped fibres, as an alternative preference is given to using ground carbon fibres. Preferred ground carbon fibres have lengths of 50 μm to 150 μm.

The carbon fibres optionally have coatings of organic sizing agents in order to enable particular modes of binding to the polymer matrix. The preferred sizing agents correspond to those mentioned for glass fibres.

Short chopped fibres and ground carbon fibres are typically added to the polymeric base materials by compounding.

For long threads, specific technical processes are typically used to arrange carbon in ultrafine threads. These filaments typically have a diameter of 3 to 10 μm. The filaments can also be used to produce rovings, wovens, nonwovens, tapes, hoses or the like.

The reinforcing fibres (D) can be present in the composition according to the invention at 0% to 40% by weight, preferably 1% to 35% by weight, particularly preferably 5% to 30% by weight and very particularly preferably 9% to 25% by weight.

The person skilled in the art is aware that the presence of the reinforcing fibres in the composition according to the invention influences the flame retardancy of the composition at any given melt viscosity. The person skilled in the art will consider themselves capable, should V-0 not be achieved at 2.00 mm, preferably 1.5 mm, of increasing the amount of polycarbonate (B) in the composition in particular by way of the present invention so that a corresponding flame retardancy of V-0 at 2.0 mm, preferably 1.5 mm, is obtained with the same melt viscosity. It is preferable according to the invention for compositions without a reinforcing fibre (D) to have a flame retardancy of at least V-0 at 2.0 mm. It is likewise preferable for compositions with a reinforcing fibre (D) to have a flame retardancy of at least V-0 at 1.5 mm. Likewise preferably, it is simultaneously preferable for compositions with a reinforcing fibre (D) to have a flame retardancy of at least 5VA at 3.0 mm.

The compositions according to the invention comprise components (A) to (D) in the percentages by weight indicated, where the percentages by weight are always based in each case (unless otherwise indicated) on the sum total of components (A) to (D). Component (E) is additionally present in the composition according to the invention.

The composition according to the invention preferably comprises components (A) to (D) in the following amounts:
4% to 75% by weight of (A), particularly preferably 7% to 70% by weight, very particularly preferably 8% to 65% by weight,
15% to 85% by weight of (B), particularly preferably 20% to 82% by weight, very particularly preferably 25% to 81% by weight,
0.050% to 0.095% by weight of (C), particularly preferably 0.065% to 0.093% by weight, very particularly preferably 0.075% to 0.091% by weight, and
5% to 30% by weight of (D), particularly preferably 6% to 25% by weight, particularly preferably 7% to 22% by weight, very particularly preferably 9% to 21% by weight,
where the % by weight are based on the sum total of components (A) to (E). The composition also additionally comprises component (E) here.

It is likewise preferable for the composition according to the invention to comprise components (A) to (C) in the following amounts:
3% to 85% by weight of (A), particularly preferably 5% to 83% by weight, very particularly preferably 6% to 80% by weight,
15% to 96% by weight of (B), particularly preferably 17% to 94% by weight, very particularly preferably 20% to 93% by weight,
0.050% to 0.095% by weight of (C), particularly preferably 0.065% to 0.093% by weight, very particularly preferably 0.075% to 0.091% by weight, and
where the % by weight are based on the sum total of components (A) to (E). The composition also additionally comprises component (E) here.

The term “comprise” is preferably to be understood here to mean “essentially consisting of” and very particularly preferably as “consisting of”. The person skilled in the art is capable, should the composition consist of the indicated components and the % by weight not add up to 100, to convert these accordingly so that 100% by weight results.

The composition according to the invention is preferably characterized in that it is free of polytetrafluoroethylene (PTFE). PTFE is known as an anti-drip agent and is often used in polycarbonate compositions in order to improve the UL94 classification. It has been found, according to the invention, that the use of PTFE in the compositions is not necessary and a UL94 classification of V-0 at 2.00 mm, preferably 1.5 mm, can nevertheless be achieved. PTFE is known to the person skilled in the art. PTFE is commercially available in a variety of product qualities. These include Hostaflon® TF2021 or PTFE blends such as Blendex® B449 (about 50% by weight of PTFE and about 50% by weight of SAN [from 80% by weight of styrene and 20% by weight of acrylonitrile]) from Chemtura.

It is also preferable for the composition according to the invention to be free of halogenated flame retardants. These are also frequently added as flame retardant to polycarbonate compositions in order to improve the flame retardancy thereof. It has been found, according to the invention, that the use of halogenated flame retardants in the compositions is not necessary and a UL94 classification of V-0 at 2.00 mm, preferably 1.5 mm, can nevertheless be achieved. Preference is given according to the invention to dispensing with all chemical compounds that include at least one halogen atom. One of the most common halogenated flame retardants is tetrabromobisphenol A oligocarbonate (TBBOC).

It is also preferable for the composition according to the invention to be free of a polysiloxane-polycarbonate block co-condensate. Such polysiloxane-polycarbonate block co-condensates have intrinsically good flame retardancy properties and are therefore often used in polycarbonate compositions.

It has been found, according to the invention, that the use of polysiloxane-polycarbonate block co-condensates in the compositions is not necessary and a UL94 classification of V-0 at 2.00 mm, preferably 1.5 mm, can nevertheless be achieved. Polysiloxane-polycarbonate block co-condensates are known to the person skilled in the art. These are often also referred to as SiCoPC. They generally contain siloxane blocks that undergo condensation with bisphenols to give corresponding polymers.

It is preferable according to the invention for the composition to be free of polytetrafluoroethylene and of a halogenated flame retardant. It is also preferable for the composition to be free of polytetrafluoroethylene and of a polysiloxane-polycarbonate block co-condensate. It is also preferable for the composition to be free of a halogenated flame retardant and of a polysiloxane-polycarbonate block co-condensate. Very particularly preferably, the composition according to the invention is free of polytetrafluoroethylene, of a halogenated flame retardant and of a polysiloxane-polycarbonate block co-condensate.

According to the invention, the composition additionally comprises
(E) a cyclic siloxane of formula (R¹₂SiO)_{y} and/or a siloxane comprising a trifunctional siloxane unit of formula R²SiO_{3/2},
   in which each R¹ independently is a monovalent aliphatic or aromatic hydrocarbon group or a fluorinated hydrocarbon group having in each case 1 to 18 carbon atoms and y is a number from 3 to 12 and
in which each R² independently is hydrogen, a monovalent aliphatic or aromatic hydrocarbon group having in each case 1 to 18 carbon atoms or a monovalent alkoxy group having 1 to 18 carbon atoms.

If (E) is a siloxane of formula (R¹ 2SiO)_{y}, it is preferable for the fluorinated hydrocarbon group that may be represented by R¹ to be selected from the group consisting of 3-fluoropropyl, 3,3,3-trifluoropropyl, 5,5,5,4,4,3,3-heptafluoropentyl, fluorophenyl, difluorophenyl and trifluorotolyl. Particularly preferably, the cyclic siloxane of formula (R¹ 2SiO)_{y} is octamethylcyclotetrasiloxane, 1,2,3,4-tetramethyl-1,2,3,4-tetravinylcyclotetrasiloxane, 1,2,3,4-tetramethyl-1,2,3,4-tetraphenylcyclotetrasiloxane, octaethylcyclotetrasiloxane, octapropylcyclotetrasiloxane, octabutylcyclotetrasiloxane, decamethylcyclopentasiloxane, dodecamethylcyclohexasiloxane, tetradecamethylcycloheptasiloxane, hexadecamethylcyclooctasiloxane, eicosamethylcyclodecasiloxane, octaphenylcyclotetrasiloxane. Particular preference is given to octaphenylcyclotetrasiloxane.

If (E) is a siloxane comprising a trifunctional siloxane unit of formula R²SiO₃/2, it is preferable for this siloxane to comprise this formula to an extent of at least 90 mol %, particularly preferably to an extent of at least 95 mol %, and very particularly preferably to an extent of 100 mol %, based on the totality of the moles of siloxane units (M unit, D unit, T unit, Q unit). The formula R²SiO_{3/2} represents a T unit. As the person skilled in the art is aware, an M unit represents the formula R₃SiO₁₂ (in which R represents hydrogen or a monovalent organic group), D represents a bifunctional unit of the formula R₂SiO (in which R is hydrogen or a monovalent organic group) and a Q unit represents a tetrafunctional siloxane unit of formula SiO₂. This trifunctional siloxane unit of formula R²SiO_{3/2} is also known as polysilsesquioxane. In addition to the T units, it can also contain M units. The structures are known to the person skilled in the art. They may have bridging structures or cage structures.

Preferably, R² is selected from hydrogen, C₁-C₁₂ alkyl, C₁-C₁₂ alkenyl, C₁-C₁₂ alkoxy, C₁-C₁₂ acyl, C₃-C₅ cycloalkyl or phenyl. Particularly preferably, R² is selected from C₁-C₆ alkyl, C₁-C₆ alkenyl, C₁-C₆ alkoxy and phenyl. Further preferably, R² is selected from methyl, ethyl, propyl, butyl and hexyl. R² is particularly preferably methyl. Particular preference is given to polymethylsilsesquioxane and octamethylsilsesquioxane.

It is preferable for (E) to be used in the composition according to the invention in amounts of 0.5% to 2.5% by weight, particularly preferably of 0.75% to 2.15% by weight, and very particularly preferably of 0.9% to 1.5% by weight.

It is preferable for the composition according to the invention not to contain any linear siloxanes having phenyl groups. It is preferable in particular for the composition not to contain any linear siloxanes having phenyl groups as disclosed in WO2012/065292 A1. Such siloxanes are generally oils, since they are oligomers. These are firstly difficult to meter into the composition and secondly can have undesired influences on the properties of the composition.

It is also preferable according to the invention for the composition to additionally comprise
(F) at least one further additive selected from the group consisting of heat stabilizers, mould-release agents, UV absorbers, compatibilizers, antioxidants, IR absorbers, flow improvers, transesterification stabilizers, additives for laser marking, impact modifiers, light-scattering diffusion additives and colourants.

Such additives as are typically added in the case of polycarbonates are described, for example, in EP-A 0 839 623, WO-A 96/15102, EP-A 0 500 496 or “Plastics Additives Handbook”, Hans Zweifel, 5th Edition 2000, Hanser Verlag, Munich. These additives may be added individually or else in a mixture. It will be appreciated that it is only permissible to add such additives and only in such amounts if they do not have a significant adverse impact on the effect according to the invention of good flame retardancy.

Suitable heat stabilizers are preferably triphenylphosphine, tris(2,4-di-tert-butylphenyl) phosphite (Irgafos® 168), tetrakis(2,4-di-tert-butylphenyl)-[1,1-biphenyl]-4,4′-diyl bisphosphonite, octadecyl 3-(3,5-di-tert-butyl-4-hydroxyphenyl)propionate (Irganox® 1076), bis(2,4-dicumylphenyl)pentaerythritol diphosphite (Doverphos® S-9228 PC), bis(2,6-di-tert-butyl-4-methylphenyl)pentaerythritol diphosphite (ADK STAB PEP-36). They are used alone or in a mixture (e.g. Irganox® B900 (mixture of Irgafos® 168 and Irganox® 1076 in a 4:1 ratio) or Doverphos® S-9228 PC with Irganox® B900/Irganox® 1076).

Useful as mould-release agents in particular are pentaerythritol tetrastearate (PETS) and glycerol monostearate (GMS).

The UV absorbers have minimum transmittance below 400 nm and maximum transmittance above 400 nm. Ultraviolet absorbers particularly suitable for use in the composition according to the invention are benzotriazoles, triazines, benzophenones and/or arylated cyanoacrylates.

Particularly suitable ultraviolet absorbers are hydroxybenzotriazoles, such as 2-(3′,5′-bis(1,1-dimethylbenzyl)-2′-hydroxyphenyl)benzotriazole (Tinuvin® 234, BASF SE, Ludwigshafen), 2-(2′-hydroxy-5′-(tert-octyl)phenyl)benzotriazole (Tinuvin® 329, BASF SE, Ludwigshafen), bis(3-(2H-benzotriazolyl)-2-hydroxy-5-tert-octyl)methane (Tinuvin® 360, BASF SE, Ludwigshafen), 2-(4,6-diphenyl-1,3,5-triazin-2-yl)-5-(hexyloxy)phenol (Tinuvin® 1577, BASF SE, Ludwigshafen), and also benzophenones such as 2,4-dihydroxybenzophenone (Chimassorb® 22, BASF SE, Ludwigshafen) and 2-hydroxy-4-(octyloxy)benzophenone (Chimassorb® 81, BASF SE, Ludwigshafen), 2,2-bis[[(2-cyano-1-oxo-3,3-diphenyl-2-propenyl)oxy]methyl]-1,3-propanediyl ester (9CI) (Uvinul® 3030, BASF SE, Ludwigshafen), 2-[2-hydroxy-4-(2-ethylhexyl)oxy]phenyl-4,6-di(4-phenyl)phenyl-1,3,5-triazine (Tinuvin® 1600, BASF SE, Ludwigshafen), tetraethyl 2,2′-(1,4-phenylenedimethylidene)bismalonate (Hostavin® B-Cap, Clariant AG) or N-(2-ethoxyphenyl)-N′-(2-ethylphenyl)ethanediamide (Tinuvin® 312, CAS no. 23949-66-8, BASF SE, Ludwigshafen).

Particularly preferred specific UV stabilizers are Tinuvin® 360, Tinuvin® 329, Tinuvin® 312, Tinuvin® 326 and/or Tinuvin® 1600, with Tinuvin® 329, Tinuvin® 326 and/or Tinuvin® 360 being very particularly preferred.

It is also possible to use mixtures of the ultraviolet absorbers mentioned.

If UV absorbers are present, the composition preferably contains ultraviolet absorbers in an amount of up to 0.8% by weight, preferably 0.05% by weight to 0.5% by weight.

Common impact modifiers, such as polyethylene waxes, for example, are known to the person skilled in the art.

Customary light-scattering diffusion additives, such as for example polyacrylates, copolyacrylates or polysilsesquioxanes, are likewise known to the person skilled in the art. The colourants are known to the person skilled in the art. They preferably include pigments, in particular titanium dioxide, and/or organic colourants. If titanium dioxide is present in the composition, it is preferably present to an extent of up to 15% by weight, very particularly preferably to an extent of up to 3% by weight, likewise preferably to an extent of up to 2% by weight, based on the overall composition. Alternatively, the titanium dioxide may also be present at 3% to 15% by weight, preferably 7% to 15% by weight, based on the overall composition. The person skilled in the art knows that titanium dioxide can have an impact on the flame retardancy of the composition. Therefore, colours that are obtained by virtue of them containing, inter alia, titanium dioxide, are particularly challenging when it comes to achieving at least V-0 at 2.00 mm, preferably 1.50 mm.

If the composition according to the invention comprises component(s) (E) and/or (F), then the amounts indicated are based in each case on the sum total of the components (A) to (E) and/or (F) present.

The composition according to the invention preferably comprises, and preferably consists of, components (A) to (F) in the following amounts:
4% to 75% by weight of (A), particularly preferably 7% to 70% by weight, very particularly preferably 8% to 65% by weight,
15% to 85% by weight of (B), particularly preferably 20% to 82% by weight, very particularly preferably 25% to 81% by weight,
0.050% to 0.095% by weight of (C), particularly preferably 0.065% to 0.093% by weight, very particularly preferably 0.075% to 0.091% by weight,
5% to 30% by weight of (D), particularly preferably 6% to 25% by weight, particularly preferably 7% to 22% by weight, very particularly preferably 9% to 21% by weight,
0.5% to 2.5% by weight of (E), particularly preferably 0.5% to 2.2% by weight of (E), very particularly preferably 0.75% to 1.5% by weight of (E), and
0% to 3% by weight of (F), particularly preferably 1% to 2.5% by weight of (F), very particularly preferably 1.3% to 2.0% by weight of (F),
where the % by weight are based on the sum total of components (A) to (F).

The composition according to the invention also preferably comprises, and preferably consists of, components (A) to (F) in the following amounts:
3% to 85% by weight of (A), particularly preferably 5% to 70% by weight, very particularly preferably 6% to 65% by weight,
14% to 96% by weight of (B), particularly preferably 20% to 94% by weight, very particularly preferably 25% to 93% by weight,
0.050% to 0.095% by weight of (C), particularly preferably 0.065% to 0.093% by weight, very particularly preferably 0.075% to 0.091% by weight,
0.5% to 2.5% by weight of (E), particularly preferably 0.5% to 2.2% by weight of (E), very particularly preferably 0.75% to 1.5% by weight of (E), and
0% to 3% by weight of (F), particularly preferably 1% to 2.5% by weight of (F), very particularly preferably 1.3% to 2.0% by weight of (F),
where the % by weight are based on the sum total of components (A) to (F).

It is particularly preferable for the composition according to the invention to consist of components (A) to (F).

The composition according to the invention also especially preferably comprises, and preferably consists of, components (A) to (F) in the following amounts:
3% to 85% by weight of (A), particularly preferably 5% to 70% by weight, very particularly preferably 6% to 65% by weight, where component (A) is a polycarbonate based on bisphenol A,
14% to 96% by weight of (B), particularly preferably 20% to 94% by weight, very particularly preferably 25% to 93% by weight, where component (B) is a polycarbonate based on bisphenol A,
0.050% to 0.095% by weight of (C), particularly preferably 0.065% to 0.093% by weight, very particularly preferably 0.075% to 0.091% by weight, where component (C) is potassium perfluoro-1-butanesulfonate and/or potassium diphenylsulfone sulfonate,
0.5% to 2.5% by weight of (E), particularly preferably 0.5% to 2.2% by weight of (E), very particularly preferably 0.75% to 1.5% by weight of (E), where component (E) is selected from octaphenylcyclotetrasiloxane, polymethylsilsesquioxane and octamethylsilsesquioxane, and
0% to 3% by weight of (F), particularly preferably 1% to 2.5% by weight of (F), very particularly preferably 1.3% to 2.0% by weight of (F), where component (F) is selected from the group consisting of heat stabilizers, mould-release agents, UV absorbers, compatibilizers, antioxidants, IR absorbers, flow improvers, transesterification stabilizers, additives for laser marking, impact modifiers, light-scattering diffusion additives and colourants,
where the % by weight are based on the sum total of components (A) to (F).

The UL94 test method and the corresponding classification are known to the person skilled in the art. In one case this is the fire performance UL94 V at 50 W, 20 mm vertical. This test method is used when ascertaining the flammability classes UL 94 V-0, V-1, V-2. The other case is described in the class UL 5V. Classification into flammability classes is performed by evaluating the afterflame and afterglow times and also burning dripping from the test specimen.

The tested test specimen thickness is classified into the grades V-0, V-1, V-2, 5VA and 5VB (vertical burn test). These represent in detail—arranged in order of degree of stringency:
V-2: extinguishing of a vertically clamped specimen within 30 seconds. Burning dripping of plastic melt allowed.
V-1: as with V-2, but burning dripping of plastic melt not allowed. Maximum 60 seconds of afterglow.
V-0: as with V-1, but flame is extinguished within 10 seconds. Maximum 30 seconds of afterglow.

Plastics that satisfy at least the classification V-2 can additionally be tested with the 500 watt flame (125 mm flame height):
5VB: Extinguishing of a vertically clamped specimen after flame application five times for five seconds in each case; no dripping allowed.
5VA: as with 5VB, additional test on a horizontally clamped sheet; neither dripping nor formation of burn holes with a diameter >1 mm are allowed.

The test bars for UL94V are pretreated as follows:
2 days/23° C./50% rel. humidity
7 days/70° C./air circulation oven
Flame height: 20 mm
Flame application time: 2×10 s

The second flame application of the sample begins immediately after the end of the first afterflame time.

The following conditions apply for the UL94 5V fire performance:
500 W, 125 mm vertical

This method is used for ascertaining the flammability classes UL 94-5VA and -5VB.

The fire performance is assessed on bars and any potential hole formation is assessed on sheets.

### Pretreatment:

2 days/23° C./50% rel. humidity.
7 days/70° C./air circulation oven

The present invention also provides for the use of 15% to 96% by weight of a polycarbonate (B) having a degree of branching of 1.01 to 1.5 mol % and not comprising any end groups of formula (I):

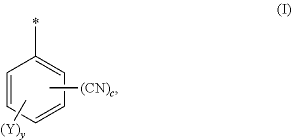

in which each Y independently is a halogen, an alkyl group having 1 to 3 carbon atoms, an alkoxy group having 1 to 3 carbon atoms, an arylalkyl group having 7 to 12 carbon atoms, an alkylaryl group or a nitro group,
y is 0 to 4 and c is 1 to 5, with the proviso that y+c is 1 to 5, and in which * represents the position at which formula (I) terminates the polycarbonate (B),
   in a composition containing
(A) linear polycarbonate,
(C) an alkali metal, alkaline earth metal or ammonium salt of aliphatic or aromatic sulfonic acid, sulfonamide or sulfonimide derivatives or combinations thereof,
(D) optionally a reinforcing fibre and
(E) a cyclic siloxane of formula (R¹²SiO)_{y} and/or a siloxane comprising a trifunctional siloxane unit of formula R²SiO_{3/2},
   in which each R¹ independently is a monovalent aliphatic or aromatic hydrocarbon group or a fluorinated hydrocarbon group having in each case 1 to 18 carbon atoms and y is a number from 3 to 12 and
   in which each R² independently is hydrogen, a monovalent aliphatic or aromatic hydrocarbon group having in each case 1 to 18 carbon atoms or a monovalent alkoxy group having 1 to 18 carbon atoms,
for achieving a V-0 classification according to UL94 at 2.00 mm, preferably 1.5 mm, layer thickness, wherein the content of component (C) in the composition is 0.05% to 0.095% by weight and where the % by weight are based on the sum total of components (A) to (D).

The components (A) to (D) and (E) indicated are preferably the components (A) to (D) and (E) according to the invention and already described above. The composition is particularly preferably the composition according to the invention in all above-described preferences and combinations of preferences, in particular in the above-mentioned amount ratios.

It has been found, surprisingly, that by adding the branched polycarbonate (B), the amount of component (C) in the composition could be reduced while at least a UL94 classification of V-0 at a layer thickness of 2.0 mm, preferably 1.5 mm, still nevertheless resulted. It has additionally been found that the compositions according to the invention comprising component (B) exhibit an improved flowability and hence better processibility than a comparable composition having a higher content of (C). The thermal properties of the composition according to the invention comprising component (B) also remain virtually comparable to those with relatively high contents of (C).

It is preferable in particular here for the linear polycarbonate (A) not to comprise any end groups of formula (I):

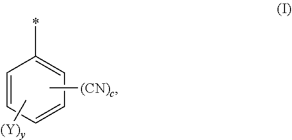

in which Y, y and c are as defined above.

### EXAMPLES

The polycarbonate-based compositions described in the following examples were prepared by compounding on a Berstorff ZE 25 extruder at a throughput of 10 kg/h. The melt temperature was 275-350° C.

Component PC-A1: Linear polycarbonate based on bisphenol A and phenol as chain terminator having a melt volume flow rate MVR of 9 cm³/(10 min) (to ISO 1133:2012-03, at a test temperature of 300° C. with a load of 1.2 kg). Contains low amounts of TPP.

Component PC-A2: Pulverulent linear polycarbonate based on bisphenol A and phenol as chain terminator having a melt volume flow rate MVR of 6 cm³/(10 min) (to ISO 1133:2012-03, at a test temperature of 300° C. with a load of 1.2 kg).

Component PC-A3: Pulverulent linear polycarbonate based on bisphenol A and phenol as chain terminator having a melt volume flow rate MVR of 19 cm³/(10 min) (to ISO 1133:2012-03, at a test temperature of 300° C. with a load of 1.2 kg).

Component PC-A4: Linear polycarbonate based on bisphenol A and phenol as chain terminator having a melt volume flow rate MVR of 9 cm³/(10 min) (to ISO 1133:2012-03, at a test temperature of 300° C. with a load of 1.2 kg). Contains no TPP.

Component PC-B: branched polycarbonate based on bisphenol A and 1,1,1-tri(4-hydroxyphenyl)ethane (THPE) as branching agent (1.3% by weight, corresponding to 1.08 mol %) and p-tert-butylphenol (BUP) as chain terminator having a melt volume flow rate MVR of 6 cm³/(10 min) (to ISO 1133:2012-03, at a test temperature of 300° C. with a load of 1.2 kg).

Component PC-B1: branched polycarbonate based on bisphenol A and 1,1,1-tri(4-hydroxyphenyl)ethane (THPE) as branching agent (1.3% by weight, corresponding to 1.08 mol %) and p-tert-butylphenol (BUP) as chain terminator having a melt volume flow rate MVR of 6 cm³/(10 min) (to ISO 1133:2012-03, at a test temperature of 300° C. with a load of 1.2 kg).

Component PC-B2: branched polycarbonate based on bisphenol A and 1,1,1-tri(4-hydroxyphenyl)ethane (THPE) as branching agent (0.381% by weight, corresponding to 0.32 mol %) and p-tert-butylphenol (BUP) as chain terminator having a melt volume flow rate MVR of 13 cm³/(10 min) (to ISO 1133:2012-03, at a test temperature of 300° C. with a load of 1.2 kg).

Component PC-B3: branched polycarbonate based on bisphenol A and 1,1,1-tri(4-hydroxyphenyl)ethane (THPE) as branching agent (0.82% by weight, corresponding to 0.68 mol %) and p-tert-butylphenol (BUP) as chain terminator having a melt volume flow rate MVR of 12 cm³/(10 min) (to ISO 1133:2012-03, at a test temperature of 300° C. with a load of 1.2 kg).

Component PC-B4: branched polycarbonate based on bisphenol A and 1,1,1-tri(4-hydroxyphenyl)ethane (THPE) as branching agent (1.06% by weight, corresponding to 0.88 mol %) and p-tert-butylphenol (BUP) as chain terminator having a melt volume flow rate MVR of 12 cm³/(10 min) (to ISO 1133:2012-03, at a test temperature of 300° C. with a load of 1.2 kg).

Component PC-B5: branched polycarbonate based on bisphenol A and 1,1,1-tri(4-hydroxyphenyl)ethane (THPE) as branching agent (1.2% by weight, corresponding to 1.0 mol %) and p-tert-butylphenol (BUP) as chain terminator having a melt volume flow rate MVR of 10.3 cm³/(10 min) (to ISO 1133:2012-03, at a test temperature of 300° C. with a load of 1.2 kg).

Component PC-B6: branched polycarbonate based on bisphenol A and 1,1,1-tri(4-hydroxyphenyl)ethane (THPE) as branching agent (1.3% by weight, corresponding to 1.08 mol %) and p-tert-butylphenol (BUP) as chain terminator having a melt volume flow rate MVR of 4.2 cm³/(10 min) (to ISO 1133:2012-03, at a test temperature of 300° C. with a load of 1.2 kg).

Component C1: Potassium perfluorobutanesulfonate (also known as Rimar salt or C4 salt) from Lanxess AG, Germany.

Component D1: CS108F-14P chopped-strand non-binding glass fibres from 3B-Fibreglass sprl, Belgium.

Component D2: CS13720 chopped-strand non-binding glass fibres from 3B-Fibreglass sprl, Belgium.

Component E1: Octaphenylcyclotetrasiloxane (OPCTS) from Shin-Etsu Co, Ltd. Japan.

Component F1: Pentaerythritol tetrastearate (PETS, Loxiol P 861/3.5 Special) mould-release agent from Emery Oleochemicals GmbH Germany.

Component F2: MACROLEX YELLOW 3G GRAN yellow dye from Lanxess, Germany.

Component F3: COLORTHERM RED 130 M red dye from Lanxess, Germany.

Component F4: LAMP BLACK 101 carbon black black pigment from Evonik, Germany.

Component F5: KRONOS 2230 titanium dioxide white pigment from Kronos Titan GmbH, Germany.

Component F6: Triphenylphosphine (TPP) from BASF SE, Germany.

Component F7: Tinuvin 329 UV absorber from BASF SE, Germany.

Component F8: Disflamoll TOF (tris(isooctyl) phosphate) from Lanxess, Germany.

Component F9: Heucodur Yellow 3R yellow pigment from Heubach GmbH, Germany.

Component F10: Bayferrox 110 M iron oxide red pigment from Lanxess, Germany.

Component F11: Irganox 1076 UV absorber from BASF, Germany

Melt volume-flow rate (MVR) was determined in accordance with ISO 1133:2012-03 (predominantly at a test temperature of 300° C., mass 1.2 kg) using a Zwick 4106 instrument from Zwick Roell. In addition, the MVR value was measured after a preheating time of 20 minutes (IMVR20′). This is a measure of melt stability under elevated thermal stress.

Shear viscosity (melt viscosity) was determined as per ISO 11443:2005 with a Göttfert Visco-Robo 45.00 instrument.

The fire performance was determined according to UL 94 V (50 W, 20 mm vertical). Pretreatment of the test bars:
2 days/23° C./50% rel. humidity
7 days/70° C./air circulation oven
Flame height: 20 mm
Flame application time: 2×10 s

The second flame application of the sample begins immediately after the end of the first afterflame time.

The following conditions apply for the UL94 5V fire performance:
500 W, 125 mm vertical

This method is used for ascertaining the flammability classes UL 94-5VA and -5VB.

The fire performance is assessed on bars and any potential hole formation is assessed on sheets.

Pretreatment:
2 days/23° C./50% rel. humidity.
7 days/70° C./air circulation oven

As a measure of heat distortion resistance, the Vicat softening temperature VST/B50 or VST/B 120 was determined according to ISO 306:2014-3 on 80 mm×10 mm×4 mm test specimens with a ram load of 50 N and a heating rate of 50° C./h or 120° C./h using a Coesfeld Eco 2920 instrument from Coesfeld Materialtest.

As a measure of heat distortion resistance temperature, the heat deflection temperature (HDT) was measured according to DIN EN ISO 75-1:2013-08 on 80 mm×10 mm×4 mm test specimens with a load of 1.8 MPa (HDT A) or 0.45 MPa (HDT B) with an HDT Vollautomat instrument from Coesfeld.

The ash content was determined according to DIN 51903:2012-11 (850° C., hold for 30 min).

TABLE 1

| Component | | V1 | E1 | E2 | E3 | E4 | E5 | E6 | E7 |
|---|---|---|---|---|---|---|---|---|---|
| PC-A1 | | 78.404124 | 58.751219 | 57.763140 | 38.989625 | 38.001546 | — | — | — |
| (% by wt.) | | | | | | | | | |
| PC-A2 | | 9.880797 | 9.880797 | 9.880797 | 9.880797 | 9.880797 | 9.880797 | 9.880797 | 9.880797 |
| (% by wt.) | | | | | | | | | |
| PC-B | | — | 19.761594 | 19.761593 | 39.523188 | 39.523187 | 78.512813 | 77.524733 | 76.536654 |
| (% by wt.) | | | | | | | | | |
| C (% by wt.) | | 0.197616 | 0.088927 | 0.088927 | 0.088927 | 0.088927 | 0.088927 | 0.088927 | 0.088927 |
| D1 (% by wt.) | | 9.880797 | 9.880797 | 9.880797 | 9.880797 | 9.880797 | 9.880797 | 9.880797 | 9.880797 |
| E1 (% by wt.) | | — | — | 0.988080 | — | 0.988080 | — | 0.988080 | 1.976159 |
| F1 (% by wt.) | | 0.444636 | 0.444636 | 0.444636 | 0.444636 | 0.444636 | 0.444636 | 0.444636 | 0.444636 |
| F2 (% by wt.) | | 0.000563 | 0.000563 | 0.000563 | 0.000563 | 0.000563 | 0.000563 | 0.000563 | 0.000563 |
| F3 (% by wt.) | | 0.001502 | 0.001502 | 0.001502 | 0.001502 | 0.001502 | 0.001502 | 0.001502 | 0.001502 |
| F4 (% by wt.) | | 0.004269 | 0.004269 | 0.004269 | 0.004269 | 0.004269 | 0.004269 | 0.004269 | 0.004269 |
| F5 (% by wt.) | | 1.185696 | 1.185696 | 1.185696 | 1.185696 | 1.185696 | 1.185696 | 1.185696 | 1.185696 |
| MVR | 300° C.; | 7.2 | 5.9 | 6.3 | 5 | 5.8 | 4.1 | 3.9 | 4.4 |
| (cm³/[ 10 min]) | 1.20 kg; | | | | | | | | |
| | 6 min | | | | | | | | |
| MVR | 300° C.; | 7.8 | 6.1 | 6.9 | 5.4 | 6.1 | 4.2 | 5 | 5.1 |
| (cm³/[ 10 min]) | 1.20 kg; | | | | | | | | |
| | 19 min | | | | | | | | |
| Melt | | | | | | | | | |
| viscosity in | | | | | | | | | |
| Pas | | | | | | | | | |
| Viscosity 1 | 300° C. | 662 | 683 | 621 | 672 | 690 | 764 | 689 | 676 |
| (50 s− 1) (ro) | | | | | | | | | |
| Viscosity 2 | | 592 | 622 | 535 | 579 | 571 | 617 | 605 | 581 |
| (100 s− 1) (ro) | | | | | | | | | |
| Viscosity 3 | | 486 | 524 | 462 | 485 | 486 | 481 | 473 | 451 |
| (200 s− 1) (ro) | | | | | | | | | |
| Viscosity 4 | | 378 | 387 | 355 | 354 | 361 | 343 | 325 | 328 |
| (500 s− 1) (ro) | | | | | | | | | |
| Viscosity 5 | | 306 | 300 | 282 | 275 | 271 | 251 | 244 | 251 |
| (1000 s− 1) (ro) | | | | | | | | | |
| Viscosity 6 | | 260 | 252 | 239 | 230 | 224 | 210 | 203 | 20 |
| (1500 s− 1) (ro) | | | | | | | | | |
| Viscosity 7 | | 130 | 126 | 120 | 116 | 113 | 107 | 105 | 101 |
| (5000 s− 1) (ro) | | | | | | | | | |
| Viscosity 1 | 280° C. | 1114 | 1160 | 1176 | 1167 | 1148 | 1289 | 1169 | 1172 |
| (50 s− 1) (ro) | | | | | | | | | |
| Viscosity 2 | | 972 | 1002 | 962 | 982 | 946 | 1009 | 919 | 942 |
| (100 s− 1) (ro) | | | | | | | | | |
| Viscosity 3 | | 825 | 828 | 792 | 801 | 766 | 774 | 717 | 719 |
| (200 s− 1) (ro) | | | | | | | | | |
| Viscosity 4 | | 642 | 613 | 585 | 582 | 559 | 520 | 490 | 490 |
| (500 s− 1) (ro) | | | | | | | | | |
| Viscosity 5 | | 479 | 455 | 435 | 432 | 406 | 378 | 356 | 347 |
| (1000 s− 1) (ro) | | | | | | | | | |
| Viscosity 6 | | 385 | 362 | 353 | 347 | 327 | 302 | 286 | 273 |
| (1500 s− 1) (ro) | | | | | | | | | |
| Viscosity 7 | | 173 | 165 | 161 | 158 | 150 | 142 | 135 | 131 |
| (5000 s− 1) (ro) | | | | | | | | | |
| Viscosity 1 | 260° C. | 2029 | 2071 | 1881 | 2125 | 2019 | 2117 | 2059 | 1854 |
| (50 s− 1) (ro) | | | | | | | | | |
| Viscosity 2 | | 1757 | 1751 | 1558 | 1745 | 1638 | 1608 | 1558 | 1434 |
| (100 s− 1) (ro) | | | | | | | | | |
| Viscosity 3 | | 1500 | 1452 | 1315 | 1407 | 1297 | 1220 | 1173 | 1098 |
| (200 s− 1) (ro) | | | | | | | | | |
| Viscosity 4 | | 1046 | 1015 | 915 | 950 | 872 | 801 | 771 | 726 |
| (500 s− 1) (ro) | | | | | | | | | |
| Viscosity 5 | | 702 | 685 | 622 | 644 | 590 | 551 | 534 | 503 |
| (1000 s− 1) (ro) | | | | | | | | | |
| Viscosity 6 | | 541 | 528 | 480 | 500 | 455 | 432 | 419 | 394 |
| (1500 s− 1) (ro) | | | | | | | | | |
| Viscosity 7 | | 226 | 221 | 206 | 213 | 196 | 188 | 185 | 173 |
| (5000 s− 1) (ro) | | | | | | | | | |
| Vicat (° C.) | VSTB - | 142.4 | 142.5 | 140.4 | 142.5 | 140.2 | 141.9 | 140.2 | 139.1 |
| | (50N); | | | | | | | | |
| | 50 K/h | | | | | | | | |
| HDT (° C.) | A (flexural | 132.2 | 132.6 | 131.2 | 133.4 | 131 | 133.1 | 131.3 | 130.4 |
| | stress = | | | | | | | | |
| | 1.8N/mm²) | | | | | | | | |
| UL94-V | 1.80 mm | V-0 | V-0 | V-0 | V-0 | V-0 | V-0 | V-0 | V-0 |
| 48 h/168 h | | V-0/V-0 | V-0/V-0 | V-0/V-0 | V-0/V-0 | V-0/V-0 | V-0/V-0 | V-0/V-0 | V-0/V-0 |
| V0/V1/V2/ | | 10/0/0/0 | 10/0/0/0 | 10/0/0/0 | 10/0/0/0 | 10/0/0/0 | 10/0/0/0 | 10/0/0/0 | 10/0/0/0 |
| failed (number) | | | | | | | | | |
| Afterflame | | N; 23/ | N; 20/ | N; 27/ | N; 27/ | N; 18/ | N; 17/ | N; 20/ | N; 23/ |
| time (s) | | N; 25 | N; 35 | N; 31 | N; 25 | N; 24 | N; 28 | N; 27 | N; 31 |
| UL94-V | 1.50 mm | V-0 | V-0 | V-0 | V-0 | V-0 | V-0 | V-0 | V-0 |
| 48 h/168 h | | V-0/V-0 | V-0/V-0 | V-0/V-0 | V-0/V-0 | V-0/V-0 | V-0/V-0 | V-0/V-0 | V-0/V-0 |
| V0/V1/V2/ | | 10/0/0/0 | 10/0/0/0 | 10/0/0/0 | 10/0/0/0 | 10/0/0/0 | 10/0/0/0 | 10/0/0/0 | 10/0/0/0 |
| failed (number) | | | | | | | | | |
| Afterflame | | N; 23/ | N; 23/ | N; 25/ | N; 27/ | N; 29/ | N; 23/ | N; 31/ | N; 20/ |
| time (s) | | N; 32 | N; 34 | N; 35 | N; 34 | N; 24 | N; 40 | N; 28 | N; 28 |
| UL94-V | 1.20 mm | V-2 | V-2 | V-2 | V-2 | V-2 | V-0 | V-0 | V-0 |
| 48 h/168 h | | V-2*/V-0 | V-2/V-2 | V-0/V-2 | V-2*/V-2* | V-0/V-2* | V-0/V-0 | V-0/V-0 | V-0/V-0 |
| V0/V1/V2/ | | 8/1/1/0 | 6/0/4/0 | 8/0/2/0 | 8/0/2/0 | 9/0/1/0 | 10/0/0/0 | 10/0/0/0 | 10/0/0/0 |
| failed (number) | | | | | | | | | |
| Afterflame | | N; 40/ | N; 66/ | N; 28/ | N; 33/ | N; 31/ | N; 32/ | N; 29/ | N; 35/ |
| time (s) | | N; 29 | N; 44 | N; 29 | N; 43 | N; 41 | N; 39 | N; 42 | N; 29 |
| UL94-5V | 3.00 mm | 5VA | 5VA | 5VA | 5VA | 5VA | 5VA | 5VA | 5VA |
| Rating (bar) | | satisfied/ | satisfied/ | satisfied/ | satisfied/ | satisfied/ | satisfied/ | satisfied/ | satisfied/ |
| 48 h/168 h | | satisfied | satisfied | satisfied | satisfied | satisfied | satisfied | satisfied | satisfied |
| (sheet) | | satisfied/ | satisfied/ | satisfied/ | satisfied/ | satisfied/ | satisfied/ | satisfied/ | satisfied/ |
| 48 h/168 h | | satisfied | satisfied | satisfied | satisfied | satisfied | satisfied | satisfied | satisfied |
| Ash content | 850.00000° C.; | 10.92 | 10.98 | 11.38 | 11.06 | 11.25 | 10.92 | 11.22 | 11.34 |
| (average) (ro) | 0.50000 h | | | | | | | | |
| (%) | | | | | | | | | |

*means second flame exposure, i.e. the sample was measured again.

As can be seen from Table 1, it is possible with a composition containing (B) but containing no more than 0.09% by weight of component (C) to achieve at least the same, if not even better, flame retardancy as with a composition devoid of (B) but with increased (C) instead. The thermal properties here are at the same time essentially identical. For the composition according to the invention, the flowability is even improved.

TABLE 2

| Component | | V2 | E8 | E9 | E10 | E11 | E12 | E13 | E14 |
|---|---|---|---|---|---|---|---|---|---|
| PC-A1 | | 68.562850 | 48.870422 | 47.882343 | 34.049227 | 33.061147 | — | — | — |
| (% by wt.) | | | | | | | | | |
| PC-A2 | | 9.880797 | 9.880797 | 9.880797 | 9.880797 | 9.880797 | 9.880797 | 9.880797 | 9.880797 |
| (% by wt.) | | | | | | | | | |
| PC-B | | — | 19.761594 | 19.761593 | 34.582789 | 34.582789 | 68.632016 | 67.643936 | 66.655857 |
| (% by wt.) | | | | | | | | | |
| C (% by wt.) | | 0.158093 | 0.088927 | 0.088927 | 0.088927 | 0.088927 | 0.088927 | 0.088927 | 0.088927 |
| D2 (% by wt.) | | 19.761594 | 19.761594 | 19.761594 | 19.761594 | 19.761594 | 19.761594 | 19.761594 | 19.761594 |
| E1 (% by wt.) | | — | — | 0.9880 | — | 0.9880 | — | 0.98808 | 1.97 |
| F1 (% by wt.) | | 0.4446 | 0.4446 | 0.4446 | 0.4446 | 0.4446 | 0.444 | 0.44463 | 0.44 |
| F2 (% by wt.) | | 0.0005 | 0.0005 | 0.0005 | 0.0005 | 0.0005 | 0.000 | 0.00056 | 0.00 |
| F3 (% by wt.) | | 0.0015 | 0.0015 | 0.0015 | 0.0015 | 0.0015 | 0.001 | 0.00150 | 0.00 |
| F4 (% by wt.) | | 0.0042 | 0.0042 | 0.0042 | 0.0042 | 0.0042 | 0.004 | 0.00426 | 0.00 |
| F5 (% by wt.) | | 1.1856 | 1.1856 | 1.1856 | 1.1856 | 1.1856 | 1.185 | 1.18569 | 1.18 |
| MVR | 300° C.; | 6.5 | 5.2 | 5.6 | 4.9 | 4.9 | 3.7 | 3.8 | 4.1 |
| (cm³/[ 10 min]) | 1.20 kg; | | | | | | | | |
| | 6 min | | | | | | | | |
| MVR | 300° C.; | 7.1 | 6 | 6.3 | 5.6 | 5.3 | 4.1 | 4.3 | 4.8 |
| (cm³/[ 10 min]) | 1.20 kg; | | | | | | | | |
| | 19 min | | | | | | | | |
| Melt | | | | | | | | | |
| viscosity in | | | | | | | | | |
| Pas | | | | | | | | | |
| Viscosity 1 | 300° C. | 914 | | 676 | | | 1149 | 979 | 987 |
| (50 s− 1) (ro) | | | | | | | | | |
| Viscosity 2 | | 634 | | 591 | | | 746 | 681 | 672 |
| (100 s− 1) (ro) | | | | | | | | | |
| Viscosity 3 | | 500 | | 449 | | | 517 | 479 | 463 |
| (200 s− 1) (ro) | | | | | | | | | |
| Viscosity 4 | | 380 | 338 | 325 | 328 | | 355 | 326 | 316 |
| (500 s− 1) (ro) | | | | | | | | | |
| Viscosity 5 | | 297 | 255 | 254 | 254 | | 270 | 244 | 239 |
| (1000 s− 1) (ro) | | | | | | | | | |
| Viscosity 6 | | 252 | 224 | 217 | 235 | | 224 | 208 | 206 |
| (1500 s− 1) (ro) | | | | | | | | | |
| Viscosity 7 | | 126 | 112 | 115 | 110 | | 113 | 107 | 102 |
| (5000 s− 1) (ro) | | | | | | | | | |
| Viscosity 1 | 280° C. | 1241 | 1253 | 1222 | 1306 | 1337 | 1646 | 1405 | 1357 |
| (50 s− 1) (ro) | | | | | | | | | |
| Viscosity 2 | | 997 | 990 | 976 | 1012 | 1094 | 1143 | 1033 | 985 |
| (100 s− 1) (ro) | | | | | | | | | |
| Viscosity 3 | | 849 | 802 | 793 | 802 | 818 | 861 | 767 | 741 |
| (200 s− 1) (ro) | | | | | | | | | |
| Viscosity 4 | | 643 | 591 | 589 | 583 | 551 | 575 | 528 | 503 |
| (500 s− 1) (ro) | | | | | | | | | |
| Viscosity 5 | | 485 | 444 | 448 | 433 | 405 | 409 | 384 | 366 |
| (1000 s− 1) (ro) | | | | | | | | | |
| Viscosity 6 | | 391 | 358 | 359 | 350 | 327 | 326 | 312 | 299 |
| (1500 s− 1) (ro) | | | | | | | | | |
| Viscosity 7 | | 173 | 161 | 162 | 158 | 150 | 150 | 144 | 140 |
| (5000 s− 1) (ro) | | | | | | | | | |
| Viscosity 1 | 260° C. | 2218 | 2298 | 2161 | 2304 | 2202 | 2500 | 2263 | 2150 |
| (50 s− 1) (ro) | | | | | | | | | |
| Viscosity 2 | | 1910 | 1899 | 1759 | 1861 | 1736 | 1828 | 1706 | 1612 |
| (100 s− 1) (ro) | | | | | | | | | |
| Viscosity 3 | | 1554 | 1546 | 1433 | 1488 | 1384 | 1389 | 1317 | 1224 |
| (200 s− 1) (ro) | | | | | | | | | |
| Viscosity 4 | | 1080 | 1061 | 993 | 1020 | 948 | 91 | 866 | 815 |
| (500 s− 1) (ro) | | | | | | | | | |
| Viscosity 5 | | 723 | 712 | 664 | 687 | 634 | 618 | 593 | 559 |
| (1000 s− 1) (ro) | | | | | | | | | |
| Viscosity 6 | | 555 | 540 | 507 | 526 | 489 | 474 | 463 | 439 |
| (1500 s− 1) (ro) | | | | | | | | | |
| Viscosity 7 | | 225 | 217 | 210 | 218 | 200 | 198 | 196 | 187 |
| (5000 s− 1) (ro) | | | | | | | | | |
| Vicat (° C.) | VSTB - | 136.4 | 136.3 | 134.7 | 136.6 | 134.5 | 136.5 | 135.2 | 132. |
| | (50N); | | | | | | | | 4 |
| | 50 K/h | | | | | | | | |
| HDT (° C.) | A (flexural | 143.9 | 143.4 | 140.3 | 143.2 | 139.8 | 141.5 | 139.5 | 138 |
| | stress = | | | | | | | | |
| | 1.8 N/mm²) | | | | | | | | |
| UL94-V | 1.80 mm | V-0 | V-0 | V-0 | V-0 | V-0 | V-0 | V-0 | V-0 |
| 48 h/168 h | | V-0/V-0 | V-0/V-0 | V-0/V-0 | V-0/V-0 | V-0/V-0 | V-0/V-0 | V-0/V-0 | V-0/V-0 |
| V0/V1/V2/ | | 10/0/0/0 | 10/0/0/0 | 10/0/0/0 | 10/0/0/0 | 10/0/0/0 | 10/0/0/0 | 10/0/0/0 | 10/0/0/0 |
| failed (number) | | | | | | | | | |
| Afterflame | | 27/20 | 20/29 | 18/29 | 17/32 | 22/29 | 18/23 | 19/23 | 20/31 |
| time (s) | | | | | | | | | |
| UL94-V | 1.50 mm | V-0 | V-0 | V-0 | V-0 | V-0 | V-0 | V-0 | V-0 |
| 48 h/168 h | | V-0/V-0 | V-0/V-0 | V-0/V-0 | V-0/V-0 | V-0/V-0 | V-0/V-0 | V-0/V-0 | V-0/V-0 |
| V0/V1/V2/ | | 10/0/0/0 | 10/0/0/0 | 10/0/0/0 | 10/0/0/0 | 10/0/0/0 | 10/0/0/0 | 10/0/0/0 | 10/0/0/0 |
| failed (number) | | | | | | | | | |
| Afterflame | | 30/30 | 23/32 | 25/35 | 19/27 | 31/29 | 34/30 | 22/34 | 28/26 |
| time (s) | | | | | | | | | |
| UL94-V | 1.20 mm | V-0 | V-0 | V-0 | V-2 | V-0 | V-0 | V-0 | V-0 |
| 48 h/168 h | | V-0/V-0* | V-0/V-0 | V-0/V-0 | V-0/V-2 | V-0/V-0 | V-0/V-0* | V-0/V-0 | V-0/V-0 |
| V0/V1/V2/ | | 10/0/0/0 | 10/0/0/0 | 10/0/0/0 | 8/0/2/0 | 10/0/0/0 | 10/0/0/0 | 10/0/0/0 | 10/0/0/0 |
| failed (number) | | | | | | | | | |
| Afterflame | | 31/26 | 32/32 | 33/39 | 25/30 | 26/25 | 34/42 | 31/37 | 26/23 |
| time (s) | | | | | | | | | |
| UL94-5V | 6.40 mm | | | | | | | | |
| Rating (bar) | | at least | at least | at least | at least | at least | at least | at least | at least |
| 48 h/168 h | | 5-VB | 5-VB | 5-VB | 5-VB | 5-VB | 5-VB | 5-VB | 5-VB |
| Class bar test | | satisfied/ | satisfied/ | satisfied/ | satisfied/ | satisfied/ | satisfied/ | satisfied/ | satisfied/ |
| (ro) | | satisfied | satisfied | satisfied | satisfied | satisfied | satisfied | satisfied | satisfied |
| Ash content | 850.00000° C.; | 20.63 | 20.81 | 20.88 | 20.75 | 21.08 | 21.02 | 20.83 | 19.98 |
| (average) (ro) | 0.50000 h | | | | | | | | |
| (%) | | | | | | | | | |

As can be gathered from Table 2, the compositions according to the invention comprising a content of a glass fibre of up to 20% by weight also have a flame retardancy of at least V-0 at 1.5 mm layer thickness. Here too, it can also be observed that the thermal properties are retained and that there is an improvement in the flowability.

TABLE 3

| Component | | V4 | E21 | E22 | E23 | E24 | E25 | E26 | E27 |
|---|---|---|---|---|---|---|---|---|---|
| PC-A4 | | 89.253396 | 69.419309 | 69.419308 | 44.626699 | 44.626698 | — | — | — |
| (% by wt.) | | | | | | | | | |
| PC-A3 | | 9.103846 | 8.151810 | 9.143515 | 8.151810 | 9.143515 | 9.143515 | 8.151810 | 7.160106 |
| (% by wt.) | | | | | | | | | |
| PC-B | | — | 19.834088 | 19.834088 | 44.626698 | 44.626698 | 89.253396 | 89.253397 | 89.253396 |
| (% by wt.) | | | | | | | | | |
| C (% by wt.) | | 0.128922 | 0.089253 | 0.089253 | 0.089253 | 0.089253 | 0.089253 | 0.089253 | 0.089253 |
| E1 (% by wt.) | | — | 0.991704 | — | 0.9917 | — | — | 0.991704 | 1.983409 |
| F1 (% by wt.) | | 0.396682 | 0.396682 | 0.396682 | 0.396682 | 0.396682 | 0.396682 | 0.396682 | 0.396682 |
| F6 (% by wt.) | | 0.029751 | 0.029751 | 0.029751 | 0.029751 | 0.029751 | 0.029751 | 0.029751 | 0.029751 |
| F7 (% by wt.) | | 0.247926 | 0.247926 | 0.247926 | 0.247926 | 0.247926 | 0.247926 | 0.247926 | 0.247926 |
| F8 (% by wt.) | | 0.009917 | 0.009917 | 0.009917 | 0.009917 | 0.009917 | 0.009917 | 0.009917 | 0.009917 |
| F9 (% by wt.) | | 0.166110 | 0.166110 | 0.166110 | 0.166110 | 0.166110 | 0.166110 | 0.166110 | 0.166110 |
| F10 (% by wt.) | | 0.003967 | 0.003967 | 0.003967 | 0.003967 | 0.003967 | 0.003967 | 0.003967 | 0.003967 |
| F4 (% by wt.) | | 0.109087 | 0.109087 | 0.109087 | 0.109087 | 0.109087 | 0.109087 | 0.109087 | 0.109087 |
| F5 (% by wt.) | | 0.550396 | 0.550396 | 0.550396 | 0.550396 | 0.550396 | 0.550396 | 0.550396 | 0.550396 |
| MVR | 300° C.; | 11.8 | 11.4 | 10.7 | 10.3 | 9.6 | 8.4 | 7.8 | 8.4 |
| (cm³/[ 10 min]) | 1.20 kg; | | | | | | | | |
| | 7 min | | | | | | | | |
| MVR | 300° C.; | 12.7 | 12.5 | 11.8 | 11.2 | 10.2 | 9.1 | 8.8 | 9.3 |
| (cm³/[ 10 min]) | 1.20 kg; | | | | | | | | |
| | 20 min | | | | | | | | |
| Vicat (° C.) | VSTB - | 140.3 | 138.7 | 140.2 | 138.7 | 140 | 138.4 | 139.4 | 136.7 |
| | (50N); | | | | | | | | |
| | 50 K/h | | | | | | | | |
| UL94-V | 3.00 mm | V-0 | V-0 | V-0 | V-0 | V-0 | V-0 | V-0 | V-0 |
| 48 h/168 h | | V-0/V-0 | V-0/V-0 | V-0/V-0 | V-0/V-0 | V-0/V-0 | V-0/V-0 | V-0/V-0 | V-0/V-0 |
| V0/V1/V2/ | | 10/0/0/0 | 10/0/0/0 | 10/0/0/0 | 10/0/0/0 | 10/0/0/0 | 10/0/0/0 | 10/0/0/0 | 10/0/0/0 |
| failed (number) | | | | | | | | | |
| Afterflame | | N; 19/N; 35 | N; 23/N; 30 | N; 28/N; 25 | N; 19/N; 19 | N; 26/N; 28 | N; 24/N; 18 | N; 24/N; 29 | N; 18/N; 20 |
| time (s) | | | | | | | | | |
| UL94-V | 2.80 mm | V-0 | V-0 | V-0 | V-0 | V-0 | V-0 | V-0 | V-0 |
| 48 h/168 h | | V-0/V-0 | V-0/V-0 | V-0/V-0 | V-0/V-0 | V-0/V-0 | V-0/V-0 | V-0*/V-0 | V-0/V-0 |
| V0/V1/V2/ | | 10/0/0/0 | 10/0/0/0 | 10/0/0/0 | 10/0/0/0 | 10/0/0/0 | 10/0/0/0 | 10/0/0/0 | 10/0/0/0 |
| failed (number) | | | | | | | | | |
| Afterflame | | N; 25/N; 25 | N; 27/N; 27 | N; 29/N; 28 | N; 13/N; 32 | N; 19/N; 32 | N; 24/N; 33 | N; 22/N; 30 | N; 20/N; 28 |
| time (s) | | | | | | | | | |

As can be gathered from Table 3, compositions without glass fibre also exhibit a good flame retardancy with virtually unchanged thermal properties.

TABLE 4

| Component | | E28 | V5 | V6 | V7 | V8 | V9 | V10 |
|---|---|---|---|---|---|---|---|---|
| PC-B1 | | 93.000 | 93.000 | | | | | |
| (% by wt.) | | | | | | | | |
| PC-B2 | | | | 93.000 | 93.000 | | | |
| (% by wt.) | | | | | | | | |
| PC-B3 | | | | | | 93.000 | 93.000 | |
| (% by wt.) | | | | | | | | |
| PC-B4 | | | | | | | | 93.000 |
| (% by wt.) | | | | | | | | |
| PC-B5 | | | | | | | | |
| (% by wt.) | | | | | | | | |
| PC-B6 | | | | | | | | |
| (% by wt.) | | | | | | | | |
| PC-A3 | | | | | | | | |
| (% by wt.) | | | | | | | | |
| PC-A2 | | 4.780 | 6.780 | 4.780 | 6.780 | 4.780 | 6.780 | 4.780 |
| (% by wt.) | | | | | | | | |
| C (% by wt.) | | 0.065 | 0.065 | 0.065 | 0.065 | 0.065 | 0.065 | 0.065 |
| E1 (% by wt.) | | 2.000 | | 2.000 | | 2.000 | | 2.000 |
| F7 (% by wt.) | | 0.120 | 0.120 | 0.120 | 0.120 | 0.120 | 0.120 | 0.120 |
| F8 (% by wt.) | | 0.010 | 0.010 | 0.010 | 0.010 | 0.010 | 0.010 | 0.010 |
| F11 (% by wt.) | | 0.025 | 0.025 | 0.025 | 0.025 | 0.025 | 0.025 | 0.025 |
| MVR | 300° C.; | 6.9 | 6.9 | 14.5 | 12.7 | 13.5 | 11.4 | 13.8 |
| (cm³/[ 10 min]) | 1.20 kg; | | | | | | | |
| | 5 min | | | | | | | |
| MVR | 300° C.; | 7.2 | 7.2 | 15.1 | 14 | 14.4 | 12.7 | 14.1 |
| (cm³/[ 10 min]) | 1.20 kg; | | | | | | | |
| | 20 min | | | | | | | |
| Vicat | VSTB - | 140.3 | 144.4 | 142.1 | 144.9 | 141.5 | 144.6 | 141.2 |
| (° C.) | (50N); | | | | | | | |
| | 50 K/h | | | | | | | |
| UL94-V | 1.50 mm | V-C | V-2 | V-2 | V-2 | V-2 | V-2 | V-2 |
| 48 h/168 h | | V-0*/V-0 | V-2/V-2 | V-2/V-2 | V-2/V-2 | V-2/V-2 | V-2/V-2 | V-2/V-2 |
| V0/V1/V2/ | | 10/0/0/0 | 1/0/9/0 | 3/2/5/0 | 0/0/10/0 | 2/0/8/0 | 0/0/10/0 | 6/014/0 |
| failed (number) | | | | | | | | |
| Afterflame | | 28/32 | 41/50 | 43/42 | 28/29 | 37/17 | 63/25 | 32/25 |
| time (s) | | | | | | | | |
| UL94-V | 1.20 mm | V-0 | V-2 | V-2 | V-2 | V-2 | V-2 | V-2 |
| 48 h/168 h | | V-0*/V-0 | V-2*/V-2 | V-2/V-2 | V-2/V-2 | V-2/V-2 | V-2/V-2 | V-0/V-2 |
| V0/V1/V2/ | | 10/0/0/0 | 3/0/7/0 | 5/0/5/0 | 0/0/10/0 | 3/1/6/0 | 1/0/9/0 | 6/0/4/0 |
| failed (number) | | | | | | | | |
| Afterflame | | 3/29 | 25/70 | 32/26 | 66/76 | 34/32 | 32/41 | 20/31 |
| time (s) | | | | | | | | |

| Component | V11 | V12 | V13 | E29 | V14 | V15 | V16 |
|---|---|---|---|---|---|---|---|
| PC-B1 | | | | | | | |
| (% by wt.) | | | | | | | |
| PC-B2 | | | | | | | |
| (% by wt.) | | | | | | | |
| PC-B3 | | | | | | | |
| (% by wt.) | | | | | | | |
| PC-B4 | 93.000 | | | | | | |
| (% by wt.) | | | | | | | |
| PC-B5 | | 93.000 | 93.000 | | | | |
| (% by wt.) | | | | | | | |
| PC-B6 | | | | 93.000 | 93.000 | | |
| (% by wt.) | | | | | | | |
| PC-A3 | | | | | | 93.000 | 93.000 |
| (% by wt.) | | | | | | | |
| PC-A2 | 6.780 | 4.780 | 6.780 | 4.780 | 6.780 | 4.780 | 6.780 |
| (% by wt.) | | | | | | | |
| C (% by wt.) | 0.065 | 0.065 | 0.065 | 0.065 | 0.065 | 0.065 | 0.065 |
| E1 (% by wt.) | | 2.000 | | 2.000 | | 2.000 | |
| F7 (% by wt.) | 0.120 | 0.120 | 0.120 | 0.120 | 0.120 | 0.120 | 0.120 |
| F8 (% by wt.) | 0.010 | 0.010 | 0.010 | 0.010 | 0.010 | 0.010 | 0.010 |
| F11 (% by wt.) | 0.025 | 0.025 | 0.025 | 0.025 | 0.025 | 0.025 | 0.025 |
| MVR | 11.6 | 11.1 | 9.6 | 5.9 | 4.6 | 19.4 | 16.8 |
| (cm³/[ 10 min]) | | | | | | | |
| MVR | 12.3 | 11.6 | 10.3 | 6.1 | 5 | 19.4 | 18.4 |
| (cm³/[ 10 min]) | | | | | | | |
| Vicat | 144.0 | 141.7 | 144.8 | 142.3 | 145.9 | 143.3 | 147.0 |
| (° C.) | | | | | | | |
| UL94-V | V-2 | V-2 | V-2 | V-0 | V-2 | V-2 | V-2 |
| 48 h/168 h | V-2/V-2 | V-2/V-2 | V-2/V-2 | V-0/V-0 | V-2/V-0 | V-2/V-2 | V-2/V-2 |
| V0/V1/V2/ | 0/0/10/0 | 6/0/4/0 | 1/0/9/0 | 10/0/00 | 7/1/2/0 | 2/0/8/0 | 0/0/10/0 |
| failed (number) | | | | | | | |
| Afterflame | 30/38 | 24/21 | 46/37 | 21/11 | 51/24 | 30/29 | 38/31 |
| time (s) | | | | | | | |
| UL94-V | V-2 | V-2 | V-2 | V-0 | V-2 | V-2 | V-2 |
| 48 h/168 h | V-2/V-2 | V-2/V-2 | V-2/V-2 | V-0/V-0 | V-0/V-2* | V-2/V-2 | V-2/V-2 |
| V0/V1/V2/ | 3/0/7/0 | 4/0/6/0 | 0/2/8/0 | 10/0/0/0 | 8/1/1/0 | 3/0/7/0 | 0/0/10/0 |
| failed (number) | | | | | | | |
| Afterflame | 30/44 | 32/36 | 65/ | 17/18 | 16/41 | 39/22 | 23/46 |
| time (s) | | | | | | | |

*means second flame exposure, i.e. the sample was measured again.

As can be seen from Table 4, it is possible to achieve a V-0 at a layer thickness of 1.50 mm and even 1.20 mm using only a degree of branching of the branched polycarbonate (component (B)) in the range according to the invention. Other degrees of branching lead to classification as V-2. At the same time, the thermal properties of the compositions according to the invention remain virtually the same.

It is apparent that a V-0 classification is achieved only in the presence of component E).

It can furthermore be gathered from the table that a composition comprising component B) (branched polycarbonate) and the claimed amount of component C) (for example, example E29), in contrast to a composition without component B) but comprising component C) in the same amount (V15), achieves V-0 classification at 1.5 mm and 1.2 mm.

1. A composition containing
(A) 3% to 85% by weight of a linear polycarbonate,
(B) 15% to 96% by weight of a polycarbonate having a degree of branching of 1.01 to 1.5 mol % and not comprising any end groups of formula (I): 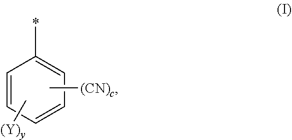
in which each Y independently is a halogen, an alkyl group having 1 to 3 carbon atoms, an alkoxy group having 1 to 3 carbon atoms, an arylalkyl group having 7 to 12 carbon atoms, an alkylaryl group or a nitro group,
y is 0 to 4 and c is 1 to 5, with the proviso that y+c is 1 to 5, and in which * represents the position at which formula (I) terminates the polycarbonate (B),
(C) 0.040% to 0.095% by weight of a compound selected from the group of alkali metal, alkaline earth metal or ammonium salts of aliphatic or aromatic sulfonic acid, sulfonamide or sulfonimide derivatives and combinations thereof, and
(D) 0% to 40% by weight of a reinforcing fibre and
(E) a cyclic siloxane of formula (R¹₂SiO)_{y} and/or a siloxane comprising a trifunctional siloxane unit of formula R²SiO_{3/2},
in which each R¹ independently is a monovalent aliphatic or aromatic hydrocarbon group or a fluorinated hydrocarbon group having in each case 1 to 18 carbon atoms and y is a number from 3 to 12 and
in which each R² independently is hydrogen, a monovalent aliphatic or aromatic hydrocarbon group having in each case 1 to 18 carbon atoms or a monovalent alkoxy group having 1 to 18 carbon atoms,
where the % by weight are based on a sum total of components (A) to (E).

2. The composition according to claim 1, wherein the composition is free of polytetrafluoroethylene.

3. The composition according to claim 1, wherein the composition is free of halogenated flame retardants.

4. The composition according to claim 1, wherein the composition is free of a polysiloxane-polycarbonate block co-condensate.

5. The composition according to claim 1, wherein the composition contains components (A) to (D) in the following amounts:
4% to 75% by weight of (A),
15% to 85% by weight of (B),
0.050% to 0.095% by weight of (C), and
5% to 30% by weight of (D),
where the % by weight are based on the sum total of components (A) to (E).

6. The composition according to claim 1, wherein component (E) is present in the composition to an extent of 0.5% to 2.5% by weight.

7. The composition according to claim 1, wherein the composition additionally comprises
(F) at least one further additive selected from the group consisting of heat stabilizers, mould-release agents, UV absorbers, compatibilizers, antioxidants, IR absorbers, flow improvers, transesterification stabilizers, additives for laser marking, impact modifiers, light-scattering diffusion additives and colourants.

8. The composition according to claim 7, wherein the composition consists of components (A) to (F).

9. The composition according to claim 1, wherein the linear polycarbonate (A) does not comprise any end groups of formula (I):

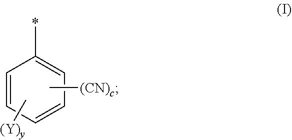

10. The composition according to any claim 1, wherein the linear polycarbonate (A) and/or the polycarbonate (B) comprise end groups of formulae (2a), (2b) and/or (2c): 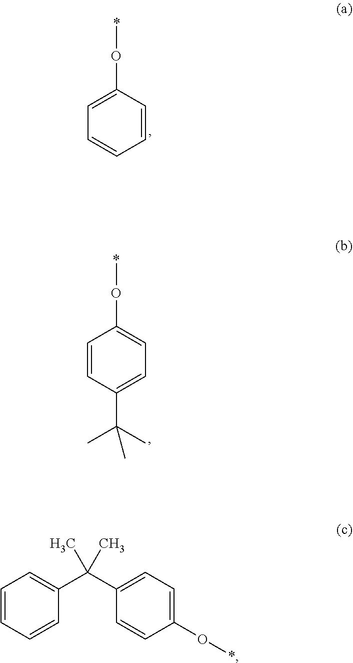
where * represents the position at which formulae (2a), (2b) and (2c) terminate the respective polycarbonate (A) and/or (B).

11. The composition according to claim 1, wherein the composition contains component (C) to an extent of 0.070% to 0.085% by weight.

12. The composition according to any of claim 1, wherein component (C) is potassium perfluorobutanesulfonate.

13. A method for achieving a V-0 classification according to UL94 at 2.00 mm layer thickness comprising providing a composition comprising 15% to 96% by weight of a polycarbonate (B) having a degree of branching of 1.01 to 1.5 mol % and not comprising any end groups of formula (I): 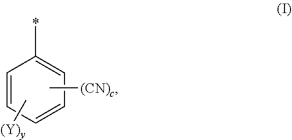
in which each Y independently is a halogen, an alkyl group having 1 to 3 carbon atoms, an alkoxy group having 1 to 3 carbon atoms, an arylalkyl group having 7 to 12 carbon atoms, an alkylaryl group or a nitro group,
y is 0 to 4 and c is 1 to 5, with the proviso that y+c is 1 to 5, and in which * represents the position at which formula (I) terminates the polycarbonate (B),
the composition containing
(A) linear polycarbonate,
(C) an alkali metal, alkaline earth metal or ammonium salt of aliphatic or aromatic sulfonic acid, sulfonamide or sulfonimide derivatives or combinations thereof,
(D) optionally a reinforcing fibre and
(E) a cyclic siloxane of formula (R¹₂SiO)_{y} and/or a siloxane comprising a trifunctional siloxane unit of formula R²SiO_{3/2},
in which each R¹ independently is a monovalent aliphatic or aromatic hydrocarbon group or a fluorinated hydrocarbon group having in each case 1 to 18 carbon atoms and y is a number from 3 to 12 and
in which each R² independently is hydrogen, a monovalent aliphatic or aromatic hydrocarbon group having in each case 1 to 18 carbon atoms or a monovalent alkoxy group having 1 to 18 carbon atoms,
wherein a content of component (C) in the composition is 0.05% to 0.095% by weight and where the % by weight are based on a sum total of components (A) to (E).

14. The method according to claim 13, wherein the linear polycarbonate (A) does not comprise any end groups of formula (I):

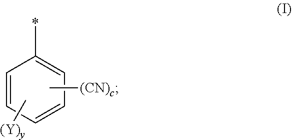

15. The method according to claim 13, wherein the composition is a composition
containing
(A) 3% to 85% by weight of the linear polycarbonate,
(B) 15% to 96% by weight of the polycarbonate having a degree of branching of 1.01 to 1.5 mol % and not comprising any end groups of formula (I): 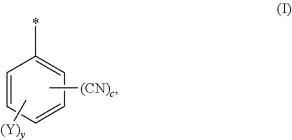
(C) 0.040% to 0.095% by weight of the compound selected from the group of alkali metal, alkaline earth metal or ammonium salts of aliphatic or aromatic sulfonic acid, sulfonamide or sulfonimide derivatives and combinations thereof, and
(D) 0% to 40% by weight of the reinforcing fibre and
(E) the cyclic siloxane of formula (R¹₂SiO)_{y} and/or a siloxane comprising a trifunctional siloxane unit of formula R²SiO_{3/2},
where the % by weight are based on a sum total of components (A) to (E).
